(19) United States
(12) Patent Application Publication
(10) Pub. No.: US 2026/0284882 A1
(43) Pub. Date: Sep. 24, 2026

(54) COLLISION AVOIDANCE SYSTEM FOR USE IN A STATE-DEPENDENT DYNAMICAL SYSTEM

(71) Applicant: Massachusetts Institute of Technology, Cambridge, MA (US)

(72) Inventors: Christopher FOURIE, Betty's Bay (ZA); Nadia Barbara Figueroa FERNANDEZ, Philadelphia, PA (US); Julie SHAH, Cambridge, MA (US)

(73) Assignee: Massachusetts Institute of Technology, Cambridge, MA (US)

(21) Appl. No.: 19/480,246

(22) PCT Filed: May 17, 2024
(86) PCT No.: PCT/US2024/029886

§ 371 Date: Oct. 30, 2025

Related U.S. Application Data
(60) Provisional application No. 63/502,958, filed on May 18, 2023.
(60) Provisional application No. 63/565,827, filed on Mar. 15, 2024.

(51) Int. Cl. B25J 9/16

(52) U.S. Cl. CPC B25J 9/1666; B25J 9/1671; B25J 9/1676

(57) ABSTRACT

Disclosed are concepts, systems and techniques for control systems, and particularly for control systems capable of controlling autonomous systems (e.g., autonomous robotic systems such as a such as manipulator) such that the autonomous systems avoid dynamic obstacles during movement in three-dimensions. The disclosed are concepts, systems and techniques are appropriate for use in collision avoidance systems and related methods for use in a state-dependent dynamical system (DS). The described systems and method ensure impenetrability, preserve stability, and ensure convergence even in the presence of one or more non-convex obstacles. Thus, the disclosed concepts, systems and techniques herein allow systems to operate in environments in which dynamic complex, non-convex obstacles are present.

### CROSS REFERENCE SECTION

This application claims benefit of U.S. Provisional Application No. 63/502,958 filed on May 18, 2023 and U.S. Provisional Application No. 63/565,827 filed on Mar. 15, 2024, which are hereby incorporated herein by reference.

### STATEMENT REGARDING FEDERALLY SPONSORED RESEARCH

This invention was made with government support under N0004-19-1-2299 awarded by Office of Naval Research. The government has certain rights in this invention.

### BACKGROUND

State-dependent dynamical systems offer adaptivity, reactivity, and robustness to perturbations, uncertainties, and changing environments (or so-called “dynamic environments”) for robot motion planning. One particular appeal of a dynamical system (DS) is its ability to operate at high bandwidths, enabling safe navigation (e.g., obstacle avoidance) within a variety of different environments and applications. However, even the most advanced DS-based obstacle avoidance techniques rely upon the assumption that obstacles can be represented with predefined geometric shapes (e.g. spheres, cylinders, ellipsoids, polygons, and star-shapes).

Moving obstacles or obstacles capable of moving are referred to as dynamic obstacles. When considering movement of multiple obstacles (i.e., multiple dynamic obstacles) in the context of robot motion planning, techniques for robot motion planning and object representation include: an averaging of multiple (per-obstacle) modulations; a composition of multiple (per-obstacle) repulsive or potential functions; or, a composition of multiple obstacles into one star-shaped obstacle. To avoid undesired behaviors, such combinations are designed to provide impenetrability (meaning the robot will not penetrate an obstacle's boundary) and convergence (meaning the robot will converge to a single target or attractor).

While many objects and surfaces can be represented by convex shapes or star-shapes, such representations may become too conservative when considering constrained or environments which contain many obstacles (so-called “dense environments”). In dense environments, such convex or star shaped object representations pose a practical limitation, as conventional methodologies do not preserve the properties of the individual modulations when the obstacles are combined to form non-convex obstacles (excluding star-shapes). Existing obstacle avoidance techniques used in DS systems often utilize non-geometric concave obstacle representations (i.e., sensor-based representations like point clouds or depth data) that suffer from the introduction of a potentially infinite number of “spurious attractors” (e.g., undesired local minima on an obstacle boundary).

### SUMMARY OF DISCLOSED EMBODIMENTS

Disclosed herein is collision avoidance system and related methods for use in a state-dependent dynamical system (DS). The described systems and method ensure impenetrability, preserve stability, and ensure convergence even in the presence of one or more non-convex obstacles. Thus, the collision avoidance system and methods described herein allow systems to operate in environments in which dynamic complex, non-convex obstacles are present. The concepts, systems and techniques described herein relate to control systems, and particularly to the problem of avoiding dynamic obstacles during movement in three-dimensions (such as for a movement of an autonomous system such as manipulator) using a DS.

In one aspect, the present disclosure is directed towards a method, comprising generating a dynamical system model of a system configured to operate in an environment; collecting data via one or more sensors; processing the collected data to generate object representations of non-convex objects in the environment; generating approximated geodesics of one more extended isosurfaces of the object representations of non-convex objects; modulating the dynamical systems model using a manifold based on approximated geodesics of the one more extended isosurfaces of the object representations of non-convex objects; and providing one or more control signals for the system.

In embodiments, the non-convex objects are dynamic non-convex objects. In embodiments, processing the collected data to generate object representations of non-convex objects in the environment comprises generating a sample-based representation of at least one non-convex object. In embodiments, generating a sample-based representation of at least one non-convex object comprises generating at least one of: a quadratic obstacle field; and an exponential obstacle field. In embodiments, processing the collected data to generate object representations of non-convex objects in the environment comprises generating a projection-based representation of at least non-convex object. In embodiments, processing the collected data to generate object representations of non-convex objects in the environment comprises generating projection-based object representations of multiple objects in the environment by combining multiple object representations into a single function; and providing one or more control signals for the system comprises providing one or more control signals to a robot which causes the robot to move in three dimensions while avoiding dynamic obstacles during the movement in three-dimensions.

In another aspect, the present disclosure is directed towards a control system for use with an autonomous system. In embodiments, the control system comprises a processing system configured to: define a dynamical system model of the autonomous system; process sensor data to define object representations of non-convex objects in an operating environment; modulate the dynamical system model using a manifold based upon approximated geodesics of one more extended isosurfaces of the object representations of non-convex objects; and provide control signals to the autonomous system based upon the modulated dynamical system model.

In embodiments, the processing system is configured to generate a sample-based object representation of at least one non-convex object in the operating environment. In embodiments, the processing system is configured to generate a projection-based object representation of at least one non-convex object in the operating environment.

In embodiments, processing sensor data to define object representations of non-convex objects in an operating environment comprises creating a quadratic obstacle field Γ_{f}(x,τ) as:

$${Γ}_{f} ( x , τ ) = α ( {‖ x - f ( τ ) ‖}_{2}^{2} - {s ( τ )}^{2} ) + 1 , ∇ {Γ}_{f} ( x , τ ) = 2 \cdot α \cdot ( x - f ( τ ) ) , {∇}^{2} {Γ}_{f} ( x , τ ) = 2 \cdot α \cdot II ,$$

in which Γ_{f}(x,τ) is an obstacle field, ƒ(τ) is a continuous function describing a path representation of the obstacle, t is a point on the representation of the obstacle, a is a weighting parameter, x is a d-dimensional state-space of a robotic system and a field scaling parameter, and s(τ) is a boundary function parameter to control a boundary of the obstacle field.

In embodiments, processing sensor data to define object representations of non-convex objects in an operating environment comprises creating an exponential field obstacle field Γ_{f}(x,τ) as

$${Γ}_{f} ( x , τ ) = exp ( α \cdot {‖ f ( x ) ‖}_{s}^{m} ) ,$$

$$∇ {Γ}_{f} ( x , τ ) = α \cdot m \cdot {‖ f ( x ) ‖}_{s}^{m - 1} \cdot \frac{f ( x )}{{‖ f ( x ) ‖}_{2}} \cdot {Γ}_{f} ( x , τ ) ,$$

$${∇}^{2} {Γ}_{f} ( x , τ ) = α \cdot m \cdot {Γ}_{f} ( x , τ ) \frac{{‖ f ( x ) ‖}_{s}^{m - 2}}{{‖ f ( x ) ‖}_{2}^{2}} ( ζ \cdot f ( x ) {f ( x )}^{T} + {‖ f ( x ) ‖}_{s} {‖ f ( x ) ‖}_{2} \cdot II ) ,$$

$$ζ ( x , τ ) = ( m - 1 ) + α \cdot m \cdot {‖ f ( x ) ‖}_{s} \cdot {( α \cdot {‖ f ( x ) ‖}_{2} - s ( τ ) )}^{m - 1} - \frac{{‖ f ( x ) ‖}_{s}}{{‖ f ( x ) ‖}_{2}} ,$$

in which Γ_{f}(x,τ) is an obstacle field, x is a d-dimensional state-space of a robotic system, m is a value and corresponds to a power to which the distance is raised, s(τ) is a boundary function parameter to control a boundary of the obstacle field, α is a weighting parameter, ζ is an additional term in the calculation, ∥ is an identity matrix, ƒ(τ) is a continuous function describing a path representation of the obstacle, ƒ(x)=x−ƒ(τ), ∥ƒ(x)∥₂=∥x−ƒ(τ)∥₂, and ∥ƒ(x)∥ₛ=(∥x−ƒ(τ)∥₂−s(τ)).

In embodiments, modulating the dynamical system model using a manifold based on approximated geodesics of one more extended isosurfaces of the object representations of non-convex objects comprises forming a modulation matrix M′(x) expressed as

$${M}^{′} ( x ) = M ( x ) + H ( x ) [ \begin{matrix}0 \\ {E}^{T} ϕ ( x )\end{matrix} ] [ 10 ] {H ( x )}^{T} ,$$

in which M(x) is a modulation matrix from a classical modulation approach where: M(x)=H(x)Λ(x)H(x)^{T}, H(x) is an orthonormal basis function [\hat{n} e₁ . . . e_{d-1}], x is a d-dimensional state-space of a robotic system, \hat{n} is a normal vector, [e₁ . . . e_{d-1}] and is a collection of basis vectors orthogonal to ∇Γ(x) used to construct the orthonormal basis H(x), E=[e₁ . . . e_{d-1}], E^{T} is a transpose of E, φ(x) is an on-manifold dynamics term, H(x)^{T} is a transpose of H(x) such that H(x)^{T}H(x) is the identity matrix I.

In embodiments, the processing system is configured to generate a projection-based object representations of objects in the operating environment by generating a projection based obstacle representation expressed as Γ(x)=exp(α·(∥P(x−r)∥₂−s)), where Γ is a gamma function, x is a d-dimensional state-space of a robotic system, Γ(x) is a projection based obstacle representation and is a scalar function, P is a projection matrix, r is a center of the object, s is an offset: where Γ(x) has a gradient which may be expressed as:

$$∇ Γ ( x ) = α \cdot \frac{Γ ( x )}{{‖ P ( x - r ) ‖}_{2}} {P}^{T} P ( x - r )$$

where P^{T} is a transposed of P and Γ(x) has a Hessian which may be expressed as:

$${∇}^{2} Γ ( x ) = α \cdot \frac{Γ ( x )}{{‖ P ( x - r ) ‖}_{2}} ( {P}^{T} P + ( \frac{α}{{‖ P ( x - r ) ‖}_{2}} - \frac{1}{{‖ P ( x - r ) ‖}_{2}^{2}} ) {P}^{T} P ( x - r ) {( x - r )}^{T} {P}^{T} P ) .$$

In embodiments, the processing system is configured to generate a projection-based object representations of multiple objects in the operating environment by combining multiple object representations into a single function.

In embodiments, the processing system is configured to generate a projection-based object representations of multiple objects in the operating environment by combining multiple object representations Γᵢ(x) into a single function expressed as:

$${\hat{Γ}}_{∇} ( x ) = - \frac{1}{ρ} log ( {\sum }_{i} exp ( - ρ \cdot {Γ}_{i} ( x ) ) ) ,$$

$$∇ {\hat{Γ}}_{∇} ( x ) = \frac{{\sum }_{i} exp ( - ρ \cdot {Γ}_{i} ( x ) ) \cdot ∇ {Γ}_{i} ( x )}{{\sum }_{i} exp ( - ρ \cdot {Γ}_{i} ( x ) )} ,$$

$${∇}^{2} {\hat{Γ}}_{∇} ( x ) = \frac{1}{\sum w ( x )} ( {\sum }_{i} ζ ( 1 , x ) - ( {\sum }_{i} ∇ w ( x ) ) ∇ {{\hat{Γ}}_{∇} ( x )}^{T} ) , ζ ( 1 , x ) = ( ∇ w ( x ) \cdot ∇ {{Γ}_{i} ( x )}^{T} + w ( x ) \cdot {∇}^{2} {Γ}_{i} ( x ) ) ,$$

$$w ( x ) = exp ( - ρ \cdot {Γ}_{i} ( x ) ) \cdot ∇ w ( x ) = - w ( x ) ρ ∇ {Γ}_{i} ( x ) ,$$

where: Γ is the gamma function, i is an index corresponding to the ith object, Γ(x) is a projection based obstacle representation, \hat{Γ}(x) is an approximation of the projection based obstacle representation, ρ is the relaxation parameter from the differentiable minimum, ζ is an additional term in the calculation, and w(x) is introduced for notation reasons.

In another aspect, the present disclosure is directed towards an autonomous system comprising a control system. In embodiments, the control system comprises a processing system configured to: define a dynamical system model of the autonomous system; process sensor data to define an object representation of at least one non-convex objects in an operating environment; modulate the dynamical system model using a manifold based upon approximated geodesics of one more extended isosurfaces of the object representations of the at least one non-convex objects; and providing control signals to the autonomous system.

In embodiments, the object representations of at least one non-convex objects comprises a sample-based representation. In embodiments, the at least one object representation corresponds to a projection-based representation. In embodiments, the processing system is configured to generate projection-based object representations of multiple objects in the operating environment by combining multiple object representations into a single function. In embodiments, the autonomous system is a robot and the processing system provides one or more control signals to the robot which cause the robot to move in three dimensions while avoiding dynamic obstacles during the movement in three-dimensions.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is perspective view of an autonomous system in an environment with obstacles;

FIG. 1B is a block diagram of an autonomous system in an environment;

FIG. 1C is perspective view of an autonomous system in an environment with sample and projection based obstacle representations;

FIG. 2 is a flow diagram of a collision avoidance process for use with a dynamical system, such as the autonomous system disclosed in FIGS. 1A-1C;

FIG. 3A is a depiction of classic modulation;

FIG. 3B is an alternative depiction of classic modulation;

FIG. 4A is a depiction of on-manifold modulation;

FIG. 4B is an alternative depiction of on-manifold modulation;

FIG. 5A is a depiction of modulation without isosurface tracking;

FIG. 5B is a depiction of modulation with partial isosurface tracking;

FIG. 5C is a depiction of isosurface tracking with C_{γ}=10;

FIG. 5D is a depiction of isosurface tracking with C_{γ}=1000;

FIG. 5E is a depiction of isosurface tracking;

FIG. 5F is an alternative depiction of isosurface tracking;

FIG. 6A is a depiction of isosurface tracking with a standard Hessian on non-convex isosurfaces;

FIG. 6B is an alternative depiction of isosurface tracking with a standard Hessian on non-convex isosurfaces;

FIG. 6C is a depiction of isosurface tracking with a pseudo-Hessian on non-convex isosurfaces;

FIG. 6D is an alternative depiction of isosurface tracking with a pseudo-Hessian on non-convex isosurfaces;

FIG. 7A is a depiction of the geodesic approximation;

FIG. 7B is a streamslice view of the geodesic approximation technique applied to a non-convex obstacle;

FIG. 8 is a flow diagram of a process for processing sensor data;

FIG. 9 is a depiction of notation for sample-based obstacle representations;

FIG. 10A is a depiction of a linear gamma field;

FIG. 10B is a depiction of an exponential gamma field;

FIG. 11A illustrates an object with ∇ at a minimum and m=1;

FIG. 11B illustrates an object with n=2 and m=1;

FIG. 11C illustrates an object with n=5 and m=1;

FIG. 11D illustrates an object with n=21 and m=1;

FIG. 12 is a depiction of various projection based obstacles;

FIG. 13A is a depiction of a covariance obstacle in two dimensions (2D);

and

FIG. 13B is a depiction of a covariance obstacle in three dimensions (3D).

### DETAILED DESCRIPTION

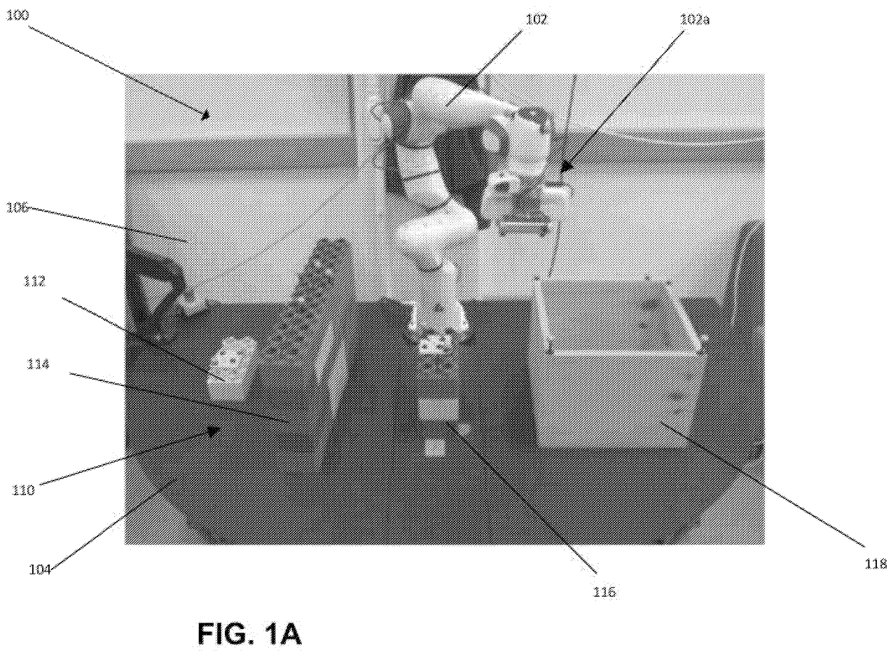

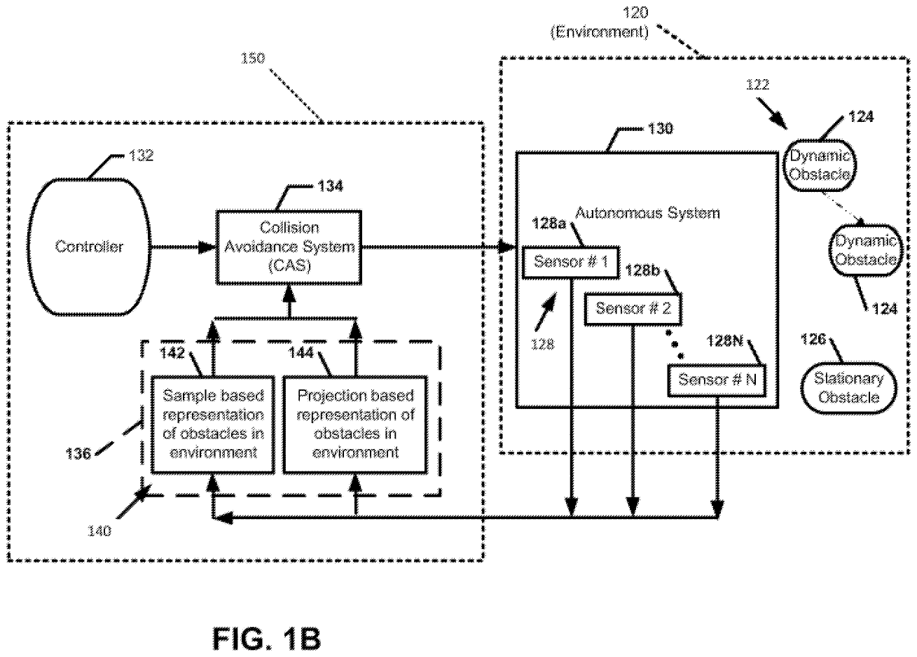

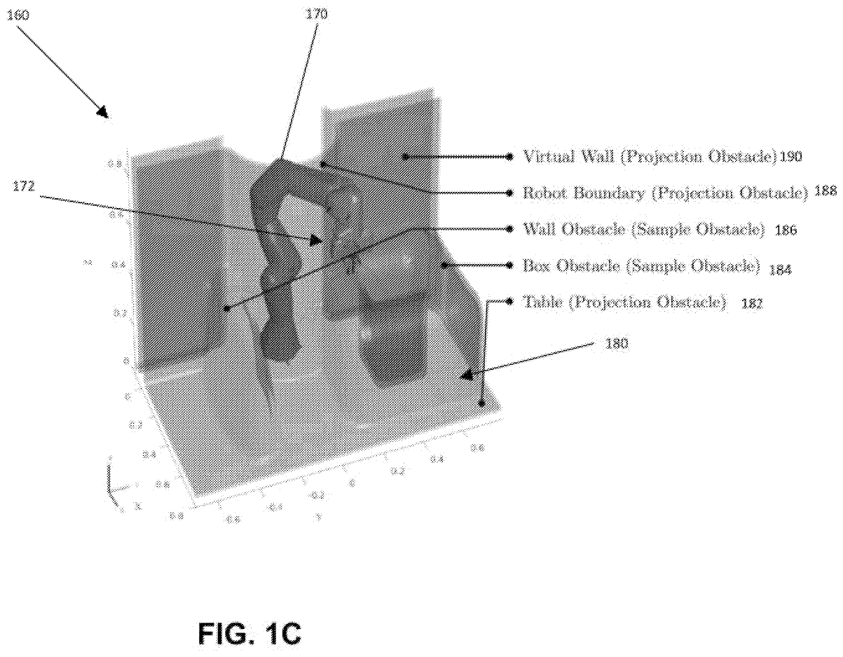

FIG. 1A is a perspective view of an environment 100 including an autonomous system 102. The autonomous system 102 may be a robot, a robotic arm (e.g., a manipulator), a drone, a transportation device (e.g., a vehicle or a plane), or any other kind of autonomous system (e.g., any system capable of movement). The autonomous system 102 includes an end effector 102a capable of movement about the environment 100. In this example embodiment, end effector 102a is illustrated as a robot arm. The environment 100 refers to a constrained workspace, for example the environment 100 includes a table 104 and a wall 106 and one or more obstacles generally denoted 110 with several obstacles 112, 114, 116, 118 being shown in FIG. 1.

To navigate around the environment 100, the end effector 102a may be required to navigate around the one or more obstacles 110 A first obstacle 112 is disposed on the table 104 adjacent to a second obstacle 114. A third obstacle 116 is disposed on the table 104 directly in front of autonomous system 102 and adjacent to a fourth obstacle 118. In embodiments, the table 104 and wall 106 may be considered obstacles as well. The disclosed collision avoidance system and method present a reactive modulated control strategy which enables the autonomous system 102, to navigate around obstacles such as obstacles 110.

FIG. 1B is a block diagram of an environment 120 including an autonomous system 130 and one or more obstacles 124, 126, generally denoted 122 (or more simply obstacles 122), the environment 120 and the autonomous system 130 may be similar to or the same as the environment 100 and the autonomous system 102 of FIG. 1A. The autonomous system 130 includes a control system 150, including a controller 132 coupled to a collision avoidance system (referred to herein as “CAS”) 134. The control system 150 is configured to: define a model of the autonomous system 130 in an environment 120; process data to define object representations of one or more obstacles 122 represented with non-convex shapes in the environment 120; modulate the model using a manifold; and provide control signals based upon the modulated model to the autonomous system 130.

The obstacles 122, which may be similar to or the same as obstacles 110 from FIG. 1A, are disposed in the environment 120 and may have complex non-convex shapes. Included among obstacles 122 are one or more dynamic obstacles 124 and/or one or more stationary obstacles 126. The stationary obstacles 126 stay in one location and position within the environment 120, while the dynamic obstacles 124 may move location and/or position in the environment 120 in a variety of ways. The dynamic obstacles 124 may move while stationary in a location (i.e. may change their position—e.g. by twisting, rotating, extending, retracting, reciprocating, oscillating in any linear or non-linear trajectory or manner). Dynamic obstacles 124 may also move around inside the environment 120 while moving to a target location (e.g. changing locations from point A to point B by travelling in any linear or non-linear manner such as moving from one side of the environment to another side of the environment).

The autonomous system 130 includes or has coupled thereto one or more sensors 128a-128N (i.e., sensors sense information around or part of autonomous system 130 but may or may not be provided as a part of the autonomous system 130). The example of FIG. 1B illustrates a plurality of sensors 128a, 128b, 128N, including: a first sensor 128a; a second sensor 128b; and a third sensor 128N, wherein N is an integer greater than 1, suggesting there may be any number of additional sensors.

Some or all of the sensors 128 may be an integral part of autonomous system 130 or may be external to the autonomous system 130. The sensors 128 may include, but are not limited to: imaging systems; motion capture systems; time of flight camera systems; light detection and ranging (LIDAR) systems; radar systems; one or more depth cameras (e.g., Realsense, Kinect); or any other type of sensors. Some embodiments may comprise multiple sensors of different types. Some embodiments may comprise one type of sensor.

Data collected by sensors 128a-128N is transmitted, fed, or otherwise provided to the CAS 134. In an embodiment where the CAS 134 is integrated into the controller 132, the data from the sensors 128 may be transmitted, fed, or otherwise provided directly to the controller 132, then provided to the CAS 134. In another embodiment, the data from the sensors 128 may be transmitted, fed, or otherwise provided directly to the CAS 134.

The sensor data is processed to provide one or more representations 140 of obstacles 122 in the environment 120. The sensor data may be processed via the CAS 134 or by a separate processor 136. The data is processed to provide a sample-based representation 142 and/or a projection-based representation 144 of the obstacles 122 in the environment 120.

The sample-based representation 142 comprises object representations of the dynamic obstacles 124 having non-convex shapes. The computationally efficient sample-based representation 142 is useful for describing arbitrary complex, non-convex obstacles. The dynamic obstacles 124 may have non-geometric concave obstacle representations.

The projection-based representation 144 of obstacles 122 is well-suited to the simple representation of convex shapes or surfaces. For example, a projection-based representation may be useful for describing continuous, well-defined surfaces, such as planes, tables, columns, cylinders, and ellipsoids.

In combination, the representations 140 can be used to represent non-convex obstacles. Such sample-based and projection-based representations can be combined to represent multiple obstacles and obstacle types (using sample-based or projection-based) with a single, continuously differentiable function.

The CAS 134 directs the autonomous system 130 to avoid collisions with one or more obstacles 122 in the environment 120. Once the data has been processed, instructions are sent to the autonomous system 130 to direct the movement of the autonomous system 130 in relation to the environment 120 and the obstacles 122. Accordingly, the CAS 134 provides signals to the autonomous system 130 that direct movements of the autonomous system 130, such that autonomous system 130 avoids the obstacles 122 while moving toward a target destination or following a preferred path to a target destination in the environment 120.

FIG. 1C is a perspective view of an environment 160 including an autonomous system 170, which may be similar to or the same as the environment 100 and the autonomous system 102 of FIG. 1A. The autonomous system 170 includes an end effector 172 capable of movement about the environment 160. The environment 160 includes various obstacles, which, in accordance with the disclosed collision avoidance system and method, are provided as one or more representations 182, 184, 186, 188, 190, generally denoted 180 (or more simply representations 180). The representations are used to enable movement of the autonomous system 170 about the environment 160 while avoiding collisions.

The obstacles include projection based obstacle representations 182, 188, 190 and sample based obstacle representations 184, 186. The projection based obstacle representations include a table 182 and a wall 190, which may be similar to or the same as the table 104 and wall 106 from FIG. 1A. A boundary projection 188 is a projection based obstacle representation that discloses the boundary of the environment 160 and/or the limits the autonomous system 170 may extend to. The sample based obstacle representation include a wall obstacle 186 and a box obstacle, which may be similar to or the same as the second obstacle 114 and fourth obstacle 118 from FIG. 1A.

The disclosed modulation approach is applied to the end effector 172 of a robot manipulator as a real-time, reactive, motion planner. The disclosed method is able to navigate around non-convex obstacles with a control frequency of 1 kHz, while updating obstacle states at 100 Hz.

The limits of the environment 160 and obstacles 180 are modeled as obstacles in the state space of the autonomous system 170. For reference, x∈ [symbol] represents the d-dimensional state-space of the autonomous system 170, the state-space refers to the Cartesian (task) space of the end-effector 172 (i.e., d>2). The robot's motion can be guided by a first-order, autonomous dynamical system (DS), f_{g}(x(τ)), describing the nominal motion plan for a robot starting from outside the obstacle boundary, such that:

$$\dot{x} ( t ) = {f}_{g} ( x ( t ) ) , {lim}_{t \to ∞} x ( t ) = x * \qquad ( 1 )$$

f_{g}(·): [symbol] → [symbol] is a continuous and differentiable vector-valued function representing a DS (vector field) that converges to a single stable equilibrium point x*∈ [symbol] (i.e., an attractor).

In this setup, it is assumed a holonomic robot is operating within a constrained workspace (i.e., environment 160) in proximity to potentially dynamic obstacles (i.e., obstacles 180). The workspace limits and moving objects are modeled as obstacles the robot should avoid, and are described by closed regions [symbol] ⊂ [symbol] , with ∂ [symbol] representing the boundary of a given region. The nominal motion generated by equation (1), referred to as global DS, does not consider obstacle or workspace constraints.

The disclosed DS modulation strategy re-shapes the flow of the global DS with respect to a set of K complex, non-convex obstacles

$$𝒪 = {\{ {𝒪}^{k} \}}_{k = 1}^{K} ,$$

such that:

$$\dot{x} ( t ) = M ( 𝒪 , x ( t ) ) \cdot {f}_{g} ( x ( t ) ) \qquad ( 2 )$$

Nominally, M( [symbol] , x(τ))∈ [symbol] is an auxiliary, continuous, matrix-valued function parameterized by the obstacles [symbol] . Equation (2) is referred to as the modulated dynamics and is called for to satisfy the following criteria: first, impenetrability: the generated dynamics will never penetrate any obstacle boundary from set

$$\partial 𝒪 = {\{ \partial {𝒪}^{k} \}}_{k = 1}^{K} ;$$

second, exit strategies: the generated dynamics will always move away from the obstacle boundaries ∂ [symbol] , including in scenarios where the concave regions are enclosed; third, convergence: any motion starting outside the obstacle boundaries ∂ [symbol] reaches the attractor x*; and fourth, computational efficiency: the disclosed DS modulation systems and methods operates at high frequency in order to guarantee strict human-safety requirements. The time-dependency of x(τ) and parameter [symbol] in M( [symbol] , x) is omitted from further equations and reference to the state space and modulation matrix M.

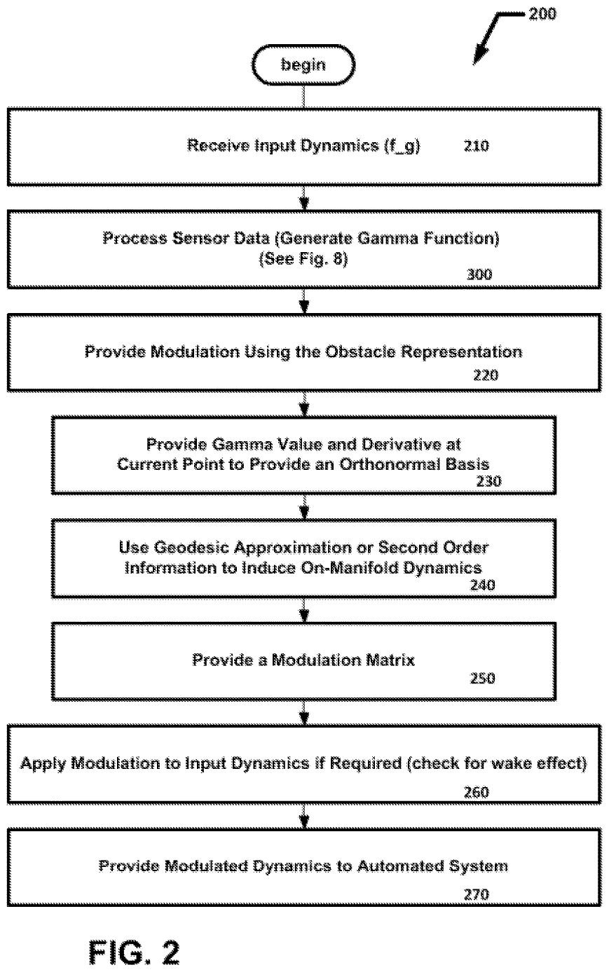

FIG. 2 is a flow diagram of a collision avoidance process 200 appropriate for use with a dynamical system. Process 200 may, for example, be similar to or the same as a process used to process data and control an autonomous system (i.e., a DS) such as the autonomous system 130 described above in conjunction with FIG. 1B.

In process 200, the collision avoidance system receives the input dynamics (f_g) in block 210. Input dynamics refers to data that describes the characteristics of the system and thus represent the input DS to be modulated. Specifically, the input dynamics represent the vector field describing a direction and speed at which to move towards a target at any point in space, but without the knowledge of the environment and the obstacles within the environment. The input dynamics describe the nominal motion of the robot and typically is the output of a control law. Other characteristics that may be included in the input dynamics include response characteristics, which are specific properties of the nominal control input or law.

Together the input dynamics and desired behavior are the nominal control input to the robot. The input dynamics and desired behavior are a vector input describing the nominal path the robot would have followed without collision avoidance and often take the form of a control law for the end effector.

In embodiments in which the input dynamics of a system are known, data (e.g., an input file or any form of input data) may be provided, transmitted, or input to the controller or CAS (for example the controller 132 or CAS 134 in FIG. 1B). In embodiments in which the input dynamics of the system are not known, the input dynamics may be provided to the controller or CAS from one or more sensors (for example the sensors 128 in FIG. 1B). For example, the data may be collected by sensors 128 and transmitted or otherwise provided to the controller 132 or CAS 134. In embodiments, a combination of known data and measured data (as measured by one or more sensors, for example) or otherwise determined dynamics of the system may be used.

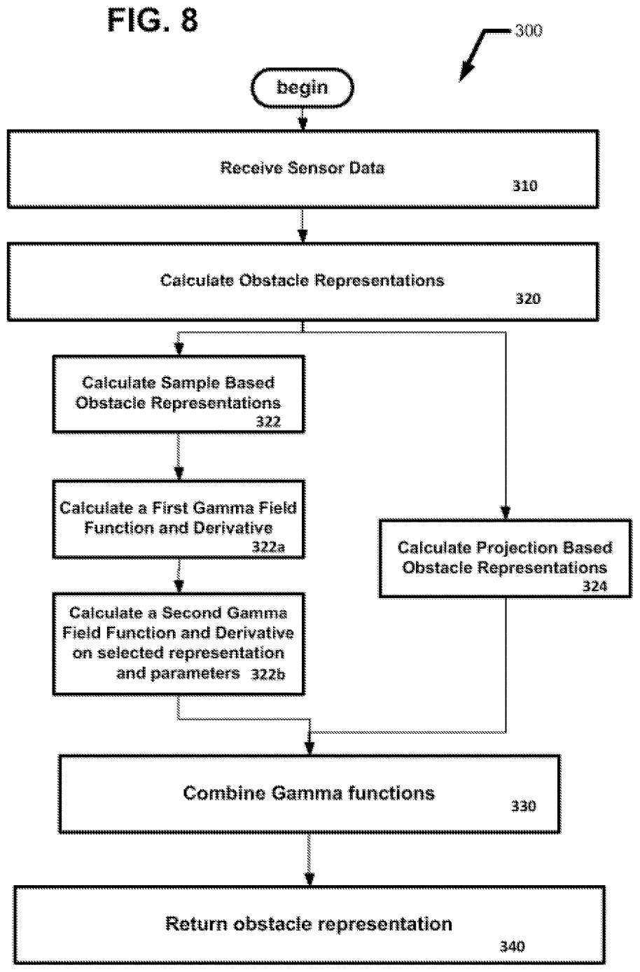

Process 200 processes the sensor data in block 300 to generate a gamma function, which will be discussed further in relation to FIG. 8.

Process 200 provides a modulation using the obstacle representation in block 220. Process 200 calculates, computes, or otherwise determines the modulation using the obstacle representation. The calculation further includes calculating a geodesic approximation.

Process 200 provides a gamma value and a derivative of the gamma value at a current point to provide an orthonormal basis function in block 230. Process 200 calculates, computes, or otherwise determines the gamma value and derivative of the gamma value at a current point to provide the orthonormal basis function (e.g. a Euclidean basis denoted H(x)). The orthonormal basis, H(x), is aligned with the gradient and tangent space of the obstacle representation function using the gradient direction. The process 200 provides a transformed orthonormal basis, H(x), that changes a reference frame to be aligned with the gradient of the obstacle representation.

The basis may be calculated or may be provided by using a projection operator. The basis, H(x), may call for explicit computation. However, explicit computation of the basis may be avoided by using a projection operator. Using the projection operator leads to increased efficiency, as an explicit basis calculation is computationally expensive, while a projection can be efficiently computed using an outer product.

Process 200 induces on-manifold dynamics in block 240. To induce the on-manifold dynamics, the process 200 uses the geodesic approximation or second order information. Second order information refers to a second derivative (i.e., the derivative of the derivative), which is a matrix that is often referred to as the Hessian. The Hessian has a number of useful properties, including providing a measure of curvature. The Hessian can be used to define a control strategy for navigation around convex obstacles. However, while the Hessian does not allow navigation around non-convex obstacles, the Hessian can be used to identify concave regions, which can be used to identify when a geodesic approach is a more appropriate strategy. The geodesic approximation is a strategy for overcoming limitations of Hessian inspired approaches. In a geodesic approximation strategy, samples are collected or otherwise received over a straight, short line on the manifold over a set of predetermined directions and then a direction is selected that reduces (and ideally minimizes) the potential along the path with regard to the attractor.

Process 200 provides a modulation matrix in block 250. Process 200 calculates, computes, or otherwise determines the modulation matrix. The disclosed approach to constructing modulation matrix M(x) avoids the generation of spurious attractors arising from collinearity (i.e., stopping on the edge of an obstacle when n and f_{g}(x) are collinear), enables isosurface tracking, and enables introduction of on-manifold strategies for circumnavigating non-convex obstacles.

Conventional modulation strategies are only capable of circumnavigating star-shaped non-convex obstacles. In addition, the reference point technique utilized by conventional techniques requires explicit placement of reference points, which can be difficult to do in a manner that ensures obstacle circumnavigation. Disclosed herein is an approach to constructing a modulation matrix M(x) that (a) avoids the generation of spurious attractors arising from collinearity (i.e. stopping on the edge of an obstacle when n and f_{g}(x) are collinear), (b) enables isosurface tracking, and (c) enables introduction of on-manifold strategies for circumnavigating nonconvex obstacles. The methodology discussed here modifies modulation M(x) to be a function of f_{g}(x).

To begin, consider partial on-manifold dynamics and spurious attractors. The isosurfaces of Γ(x) are considered with different values of γ>1∈ [symbol] , i.e., the γ-manifolds are considered as (d−1)-manifolds which can be circumnavigated or used as level-sets to navigate between manifolds (e.g., from γ=1 to γ>1 to escape non-convex regions). [symbol] is a mathematical continuity class, accordingly [symbol] differentiability means that the function is a second order differentiable. Due to the [symbol] -differentiability requirement enforced on the obstacle representation function, Γ(x), the γ-manifolds will always be smooth (i.e., no discontinuities). From herein, the γ- is dropped and such γ-manifolds are referred to as manifolds.

An explicitly decomposed modulation for the off-diagonal elements may be expressed as:

$${Λ}^{′} ( x ) = Λ ( x ) + [ \begin{matrix}0 \\ {E}^{t} ϕ ( x )\end{matrix} ] [ \begin{matrix}1 & 0\end{matrix} ] \qquad ( 3 )$$

with φ(x)∈ [symbol] and 0=0_{1×(d-1)}. Here, φ(x) is an on-manifold dynamics term: an auxiliary direction in Euclidean space that is projected onto the tangent plane (i.e., φ′(x)=E(x)^{T}φ(x)). Within these equations, E=[e₁ e₂ . . . e_{d-1}]∈ [symbol] is the collection of basis vectors orthogonal to ∇Γ(x) that are used to construct the orthonormal basis H(x).

To obtain the modulation matrix formulation, equation (3) is inserted into a classical modulation approach: M(x)=H(x)Λ(x)H(x)^{T}, with H(x) defined as:

$$H ( x ) = [ {\begin{matrix}\hat{n} & {e}_{1} & … & e\end{matrix}}_{d - 1} ] , {H ( x )}^{T} H ( x ) = I .$$

A modulation matrix may be formulated as:

$${M}^{′} ( x ) = H ( x ) {Λ}^{′} ( x ) {H ( x )}^{T} = M ( x ) + H ( x ) [ \begin{matrix}0 \\ {E}^{t} ϕ ( x )\end{matrix} ] [ \begin{matrix}1 & 0\end{matrix} ] {H ( x )}^{T} \qquad ( 4 )$$

Incorporating H(x) from H(x)=[\hat{n} e₁ . . . e_{d-1}], H(x)^{T}H(x)=I into the second term in equation (4) yields

$$H ( x ) [ \begin{matrix}0 \\ {E}^{t} ϕ ( x )\end{matrix} ] [ \begin{matrix}1 & 0\end{matrix} ] {H ( x )}^{T} = {EE}^{T} \cdot ϕ ( x ) {n}^{T} .$$

To better understand this approach, consider the isosurface of Γ(x)=γ to be a smooth manifold, [symbol] , with an associated tangent space Tₚ [symbol] , described by E. The effect of introducing φ(x) is to induce on-manifold dynamics, scaled by [symbol] n, f_{g}(x) [symbol] , using the manifold-projection matrix EE^{T}:

$$\begin{matrix}\dot{x} = {M}^{′} ( x ) {f}_{g} ( x ) \\ = M ( x ) {f}_{g} ( x ) + E {E}^{T} ϕ ( x ) {n}^{T} {f}_{g} ( x )\end{matrix} \qquad ( 5 )$$

Hence, if φ(x)≠0 any spurious attractors stemming from collinearity of [symbol] \hat{n}, v [symbol] =±∥v∥₂ with v=f_{g}(x) are never introduced, as the second term in equation (5) will induce motion in the tangent space. Thus, to remove spurious attractors on the boundary, set φ(x)=δ·ψ( [symbol] n, v [symbol] )·eᵢ, i∈{1, . . . , (d−1)}, where ψ(ζ) acts to enable the effect when ζ→−1, and disable it otherwise. For this purpose, ψₖ(ζ)=max(0,(−ζ)^{k}), with k∈[1, 3, 5, . . . ].

To ensure that the effect is only active at low values of Γ(x), φ(x) is constructed such that Γ(x)→∞⇒M(x)=∥:

$$ϕ ( x ) = \{ \begin{matrix}δ / {Γ ( x )}^{2} \cdot {ψ}_{k} ( 〈 n , v 〉 ) \cdot {e}_{i} & 〈 {e}_{i} , v 〉 \geq 0 \\ 0 & otherwise\end{matrix} \qquad ( 6 )$$

This introduces the disclosed modulation strategy as a piece-wise smooth (PWS) dynamical system governed by the switching function [symbol] eᵢ, v [symbol] , with the first term in equation (5) being continuous everywhere and the second term subject to the discontinuity shown in equation (6). Interestingly, it resembles the form of a Fillipov system with a discontinuous set defined by [symbol] eᵢ, v [symbol] ≥0. Equation (5) can be re-written as a decomposition of velocity along ∇Γ(x) and the effective tangent space velocity as:

$$\begin{matrix}\dot{x} = {M}^{′} ( x ) {f}_{g} ( x ) = {H ( x ) [ {\dot{x}}_{n} {\dot{x}}_{E} ]}^{T} \\ = H ( x ) [ \begin{matrix}{Λ}_{n} {n}^{T} {f}_{g} ( x ) \\ {E}^{T} ϕ ( x ) {n}^{T} {f}_{g} ( x ) + {Λ}_{E} {E}^{T} {f}_{g} ( x )\end{matrix} ]\end{matrix} \qquad ( 7 )$$

This follows from

$${Λ}^{′} = [ \begin{matrix}{Λ}_{n} & 0 \\ ϕ ( x ) & {Λ}_{E}\end{matrix} ] .$$

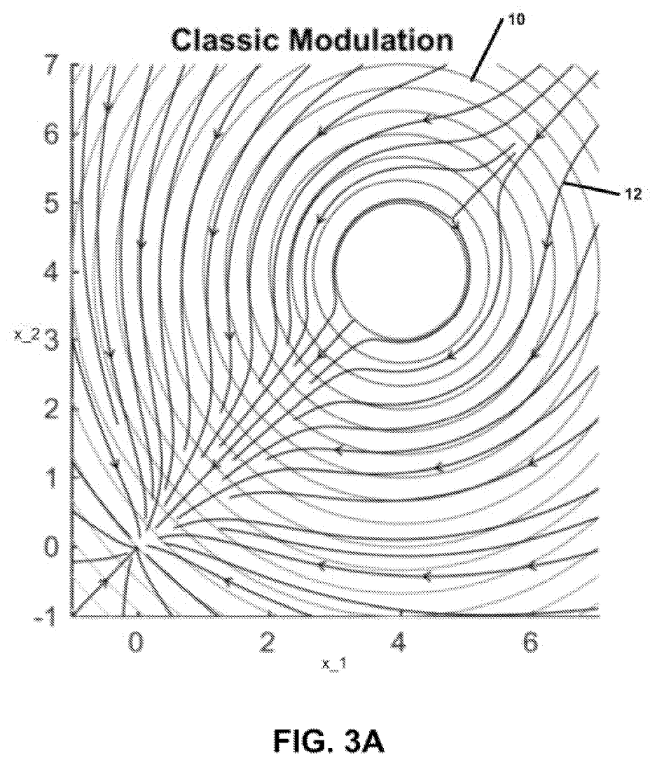

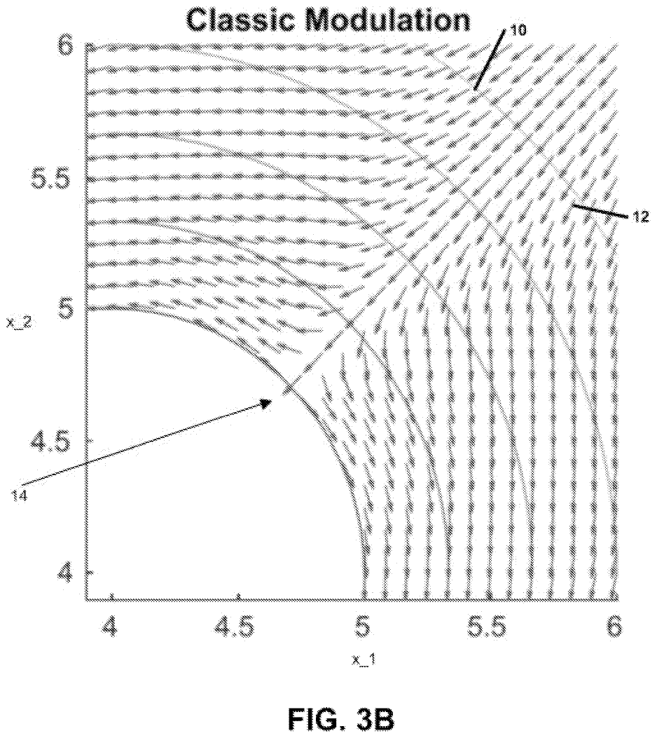

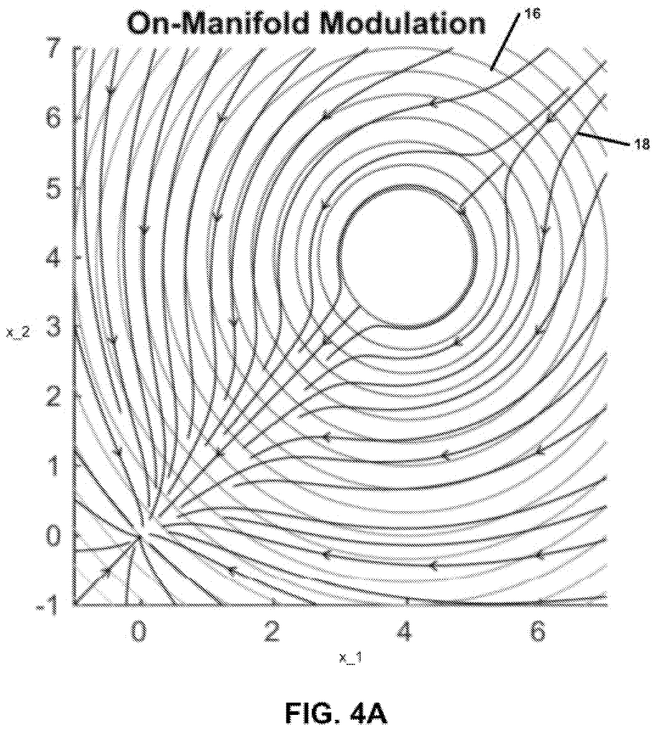

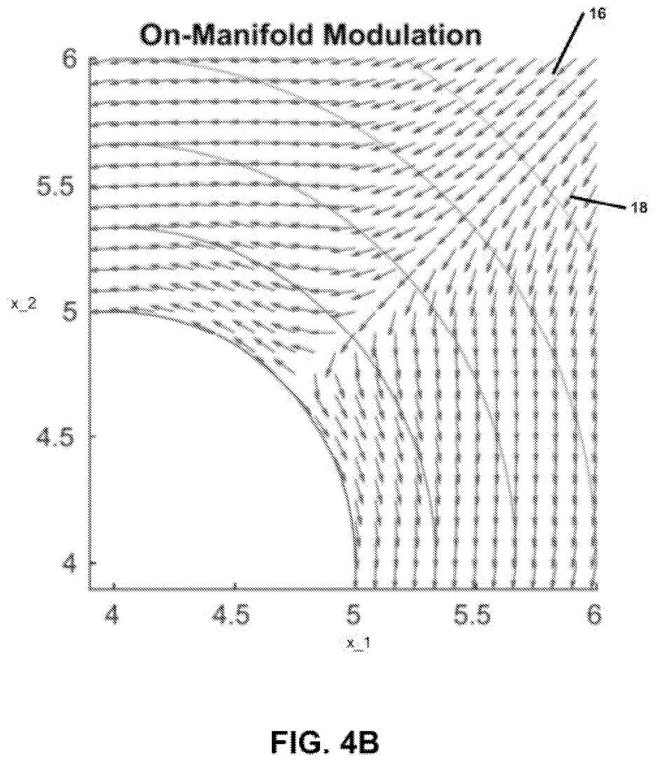

In order to induce tangent space velocities at the collinearity cases (and consequently avoid spurious attractors) one must ensure that (Λ_{E}E^{T}+E^{T}φ(x)n^{T})≠0_{d-1×d}. The effect of this method on the spurious attractor arising due to collinearity is illustrated in FIGS. 3A-4B for a spherical obstacle and linear DS f_{g}(x).

FIGS. 3A-4B illustrate a comparison of classic modulation and on-manifold modulation. The x dimensions are the system state, the axis accordingly is x_1 and x_2. Like reference numbers represent like elements among the several views.

FIG. 3A illustrates classic modulation. Illustrated are isosurfaces of the obstacle distance function, which are given for example by reference numeral 10, and streamlines demonstrating system behavior, which are given for example by reference numeral 12. The streamlines illustrate lines showing how the system will act in the presence of an obstacle.

Referring now to FIG. 3B, it can be seen collinearity of n and f_{g}(x) leads to a spurious attractor. FIG. 3B is an enlarged view of FIG. 3A. The spurious attractor is illustrated by reference numeral 14, which directly intersects the obstacle boundary at rough coordinates x_1=4.75, x_2=4.75.

FIG. 4A is a depiction of on-manifold modulation in accordance with the concepts described herein. Illustrated are isosurfaces of the obstacle distance function, which are given for example by reference numeral 16, and streamlines demonstrating system behavior, which are given for example by reference numeral 18. In FIG. 4A, the spurious attractor is no longer present at the obstacle boundary.

As can be seen from FIG. 4B, applying φ(x) in accordance with equation (6)), leads to velocities in the tangent space of [symbol] , eliminating the spurious attractor associated with collinearity, θ=0.1, k=1001. FIG. 4B is an enlarged view of FIG. 4A. The spurious attractor due to collinearity of n and f_{g}(x) can be eliminated using off-diagonal elements in the Λ(x) matrix. Overall modulation performance remains unaffected in FIGS. 3A and 4A, while the spurious attractor is removed in FIG. 4B.

In considering interpretation, following the hairy ball theorem and the proposed modulation, a non-zero continuous tangent vector field does not exist for obstacle boundaries diffeomorphic to even-dimensional spheres ( [symbol] ), implying one or more spurious attractors depending on how the discontinuous or vanishing vector field is designed. Hence, to remove a spurious attractor, a single discontinuity is artificially introduced via eᵢφ(x) on the obstacle boundary when [symbol] \hat{n}, \hat{v} [symbol] =1 and therefore ∥φ(x)∥₂=ψₖ(1)=0. Even though the disclosed on-manifold modulation strategy results in a PWS dynamical system impenetrability is preserved and, as opposed to conventional methods, global convergence is achieved.

For impenetrability, an obstacle with arbitrary shape [symbol] ∈ [symbol] represented by a function Γ(x): [symbol] → [symbol] (as defined in equations (16)-(19)). Any trajectory x(t), t∈[0, ∞), that starts outside the obstacle boundary (i.e., Γ(x(0))≥1), and evolves according to dynamics with modulation constructed by equation (5) and arbitrary DS f_{g}(x), will never penetrate the obstacle, i.e., Γ(x(t))≥1, t∈(0, ∞).

With the disclosed approach, impenetrability is ensured for arbitrary non-convex obstacles and arbitrary DS f_{g}(x) (i.e., f_{g}(x) can be linear, non-linear, multi-target, limit cycle, etc.). Convergence towards a unique equilibrium point x*∈ [symbol] for non-convex obstacles relies on convergence for convex obstacles. Further, the global DS to be modulated, f_{g}(x)=−(x−x*), is a linear system that is globally asymptotically stable (G.A.S) towards a single attractor x*∈ [symbol] ensured via Lyapunov theory.

In considering convergence for convex obstacles, consider a linear DS f_{g}(x)=−(x−x*) and a convex obstacle [symbol] ∈ [symbol] represented by Γ(x): [symbol] → [symbol] (as defined in equations (16)-(19)). If f_{g}(x) is modulated according to equation (5) around the boundary Γ(x)=1, then any trajectory x(t), t∈[0, ∞], that starts outside the obstacle boundary, i.e., Γ(x(0))≥1, converges to x* if there exists P [symbol] 0 such that n^{T}Peᵢ>0, with [symbol] 0 denoting positive definiteness of a matrix.

By introducing tangent space dynamics into the modulation strategy impenetrability and convergence can be ensured for convex obstacles without inducing any saddle points, local minima or spurious attractors, and without the need for a reference direction. Furthermore, the discontinuity introduced by φ(x) in equation (6) does not hinder global stability and convergence to x*, in fact, it is necessary due to the hairy ball theorem. To preserve the guarantees for arbitrary non-convex obstacles, the disclosed approach tracks isosurfaces Γ(x)=γ>1 that can be approximated as convex shapes and used to circumnavigate non-convex regions. Further, disclosed is a suite of local on-manifold navigation strategies for highly concave regions. These approaches follow and extend the presented modulation strategy (presented in equation (3)-(5)), yet are applicable to non-convex shapes by re-defining and re-parameterizing Λ(x) and φ(x).

In considering isosurface tracking, consider a form of M(x)=H(x)Λ′(x)H(x)^{T}, such that:

$${Λ}^{′} ( x ) = Λ ( x ) + {[ \begin{matrix}{λ}_{11}^{′} & 0\end{matrix} ]}^{T} [ \begin{matrix}1 & 0\end{matrix} ] \qquad ( 8 )$$

Where

$$Λ ( x ) = diag ( [ \begin{matrix}1 - \frac{1}{Γ ( x )} & 1 + \frac{1}{Γ ( x )} & … & 1 + \frac{1}{Γ ( x )}\end{matrix} ] ) .$$

Consider the velocity along the gradient of n, \dot{x}ₙ (such that \dot{x}=H(x)[\dot{x}ₙ \dot{x}_{E}]^{T}), for this system:

$${\dot{x}}_{n} = c ( 1 - \frac{1}{Γ ( x )} + {λ}_{11}^{′} ) {n}^{T} {f}_{g} ( x ) \qquad ( 9 )$$

c is a term introduced to maintain convergence properties. Solving for λ′₁₁ at \dot{x}ₙ=0, the system can track isosurface Γ(x)=γ by setting the following:

$${λ}_{11}^{′} = \frac{1}{γ} - 1 \qquad ( 10 )$$

The constant c can be set to γ to maintain the original system's convergence properties (i.e., that Γ(x)→∞⇒M(x)=∥); however, the sign of n^{T}f_{g}(x) affects the system's stability. n^{T}f_{g}(x)<0 will result in exact manifold tracking, but n^{T}f_{g}(x)>0 represents an unstable dynamical system, which will cause movement toward the obstacle boundary when Γ(x)<γ. To correct for this, function φ(Γ(x), γ, u, f_{g}(x)), referred to as φ(u) to ease notation:

$$φ ( u ) = \{ \begin{matrix}- 1 & Γ ( x ) < γ ∧ {u}^{T} {\hat{f}}_{g} ( x ) > 0 \\ 1 & otherwise\end{matrix} \qquad ( 11 )$$

The function can be leveraged in equation (8) as follows:

$${λ}_{11}^{′} = γ \cdot φ ( n ) ( \frac{1}{γ} - \frac{1}{Γ ( x )} ) - ( 1 - \frac{1}{Γ ( x )} ) \qquad ( 12 )$$

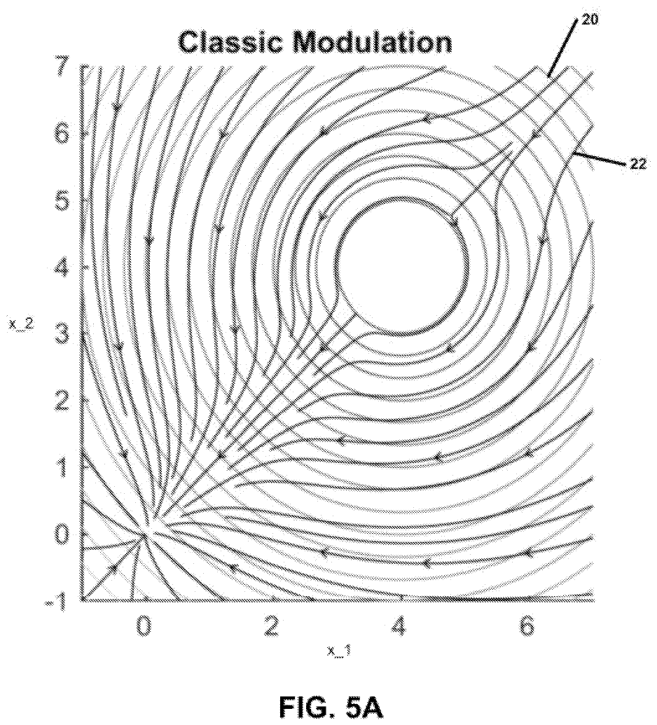

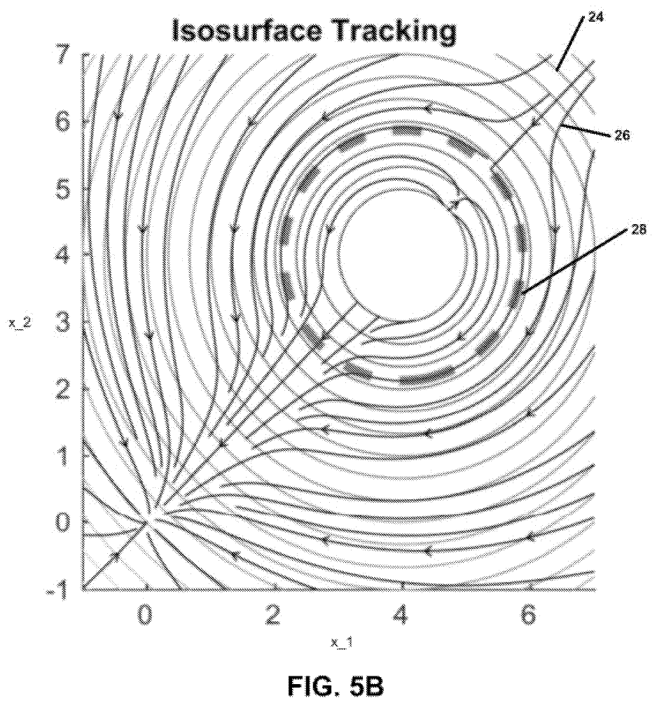

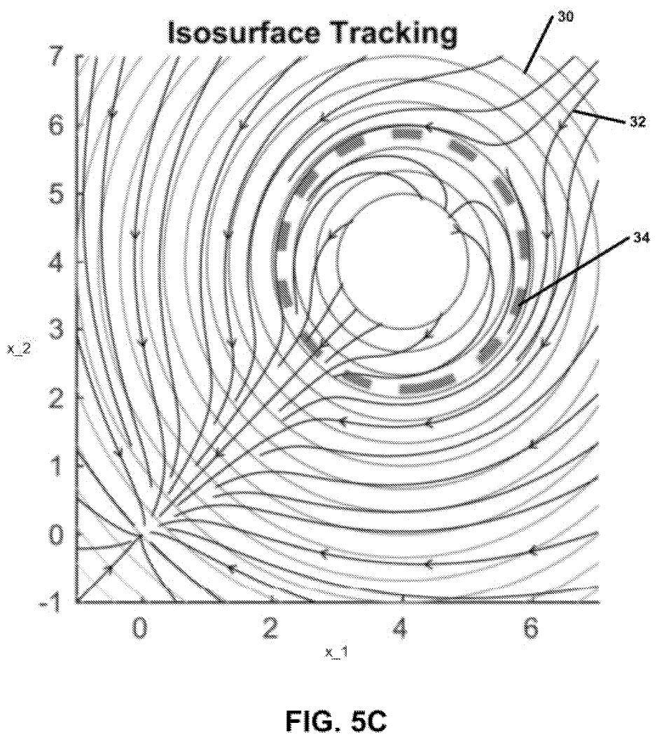

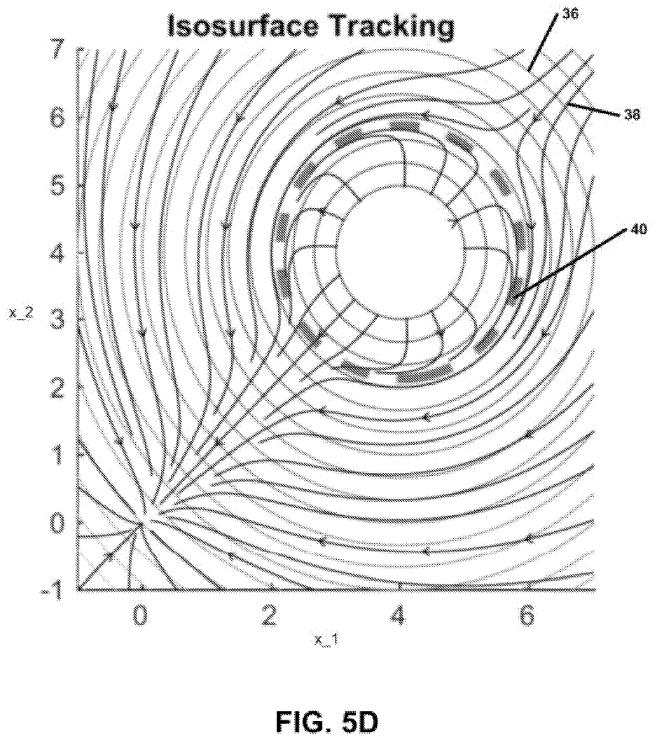

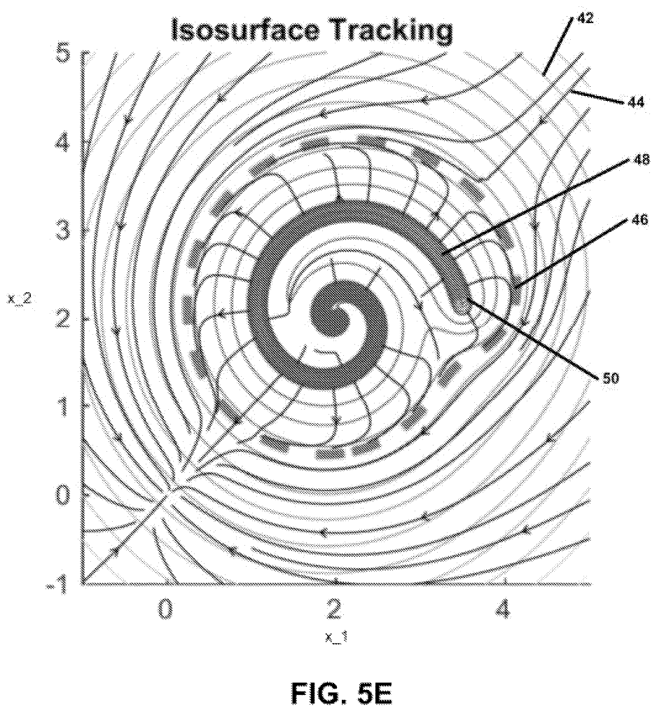

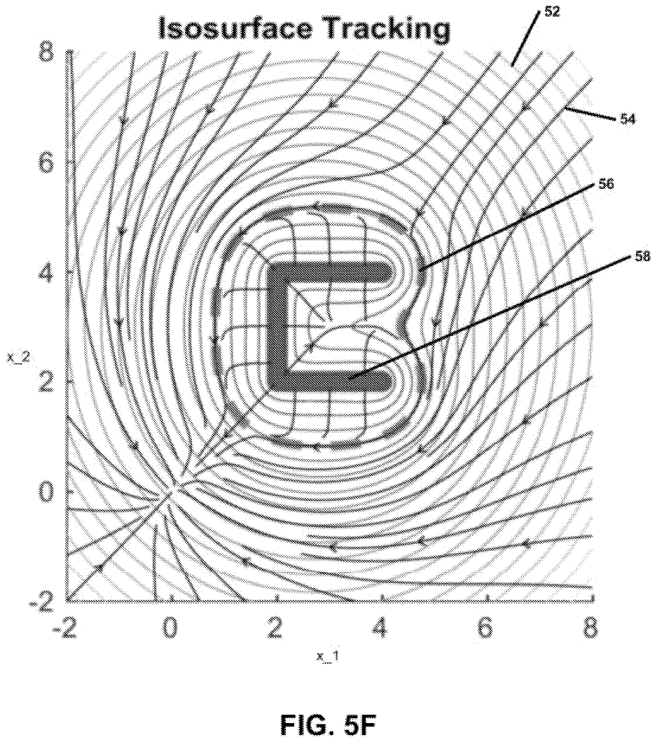

FIGS. 5A-5B depicts the effect of this, and demonstrates how the disclosed methodology can enable partial isosurface tracking.

FIGS. 5A-5F depict the elements of isosurface tracking, by combining tangent space navigation with gradient ascent, accordingly specific isosurfaces can be tracked upon which local exit strategies are employed for circumnavigation. The x dimensions are the system state, the axis accordingly is x_1 and x_2. Like reference numbers represent like elements among the several views.

FIG. 5A is a depiction of modulation without isosurface tracking. Illustrated are isosurfaces of the obstacle distance function, which are given for example by reference numeral 20, and streamlines demonstrating system behavior, which are given for example by reference numeral 22. FIG. 5A illustrates a starting point for later comparisons shown in subsequent figures. As the isosurface tracking concepts are introduced, the effects are shown in the subsequent figures.

FIG. 5B is a depiction of modulation with partial isosurface tracking. Illustrated are isosurfaces of the obstacle distance function, which are given for example by reference numeral 24, and streamlines demonstrating system behavior, which are given for example by reference numeral 26. A selected isosurface is illustrated as a dashed line, which is given for example by reference numeral 28. The selected isosurface is the target. FIG. 5B demonstrates that the modulation technique disclosed herein may be modified to operate at a “fixed distance” from the target.

FIGS. 5A-5B illustrate partial isosurface tracking, an offset on λ₁₁ enables isosurface tracking, a correction may be employed to ensure stability. The correction ensures dynamic stability based on the direction of the obstacle function and the nominal dynamics f_g (e.g., equations 11 and 12). Note that in this format, partial isosurface tracking ensures velocity \dot{x}ₙ≥0 when Γ(x)≤γ. Isosurface tracking effectively shifts the boundary of the obstacle to Γ(x)=γ, maintaining the impenetrability and convergence guarantees of the original system.

FIGS. 5C-5D depict full isosurface tracking. FIGS. 5C-5D illustrate how the tracking isosurface can be shifted and how manifold tracking and ascent to the isosurface can be traded off based on the parameters C. C_{γ} affects the width of the tracking band, and can be used to balance gradient ascent with induced tangent space dynamics. FIG. 5C is a depiction of isosurface tracking with C_{γ}=10. Illustrated are isosurfaces of the obstacle distance function, which are given for example by reference numeral 30, and streamlines demonstrating system behavior, which are given for example by reference numeral 32. A selected isosurface is illustrated as a dashed line, which is given for example by reference numeral 34. FIG. 5D is a depiction of isosurface tracking with C_{γ}=1000. Illustrated are isosurfaces of the obstacle distance function, which are given for example by reference numeral 36, and streamlines demonstrating system behavior, which are given for example by reference numeral 38. A selected isosurface is illustrated as a dashed line, which is given for example by reference numeral 40. FIG. 5D illustrates how notably close to the tracking isosurface before on-manifold dynamics become active. As opposed to FIG. 5C, wherein the effect is apparent earlier.

FIGS. 5E-5F depict the combination of isosurface tracking with a narrow band (i.e., gradient ascent) and the obstacle exit strategy methodology allows for non-convex obstacles to be represented and circumnavigated using a local strategy. FIG. 5E is a depiction of isosurface tracking. Illustrated are isosurfaces of the obstacle distance function, which are given for example by reference numeral 42, and streamlines demonstrating system behavior, which are given for example by reference numeral 44. FIG. 5E includes a target isosurface illustrated by a dashed line, which is given for example by reference numeral 46, and one or more obstacle representations, which are given for example by reference numeral 48. For the obstacle representations, the circles, for example a circle is referred to by reference numeral 50, are points. FIG. 5E illustrates how gradient ascent allows escape from non-convex regions in the obstacle.

FIG. 5F is an alternative depiction of isosurface tracking. Illustrated are isosurfaces of the obstacle distance function, which are given for example by reference numeral 52, and streamlines demonstrating system behavior, which are given for example by reference numeral 54. FIG. 5F includes a target isosurface illustrated by a dashed line, which is given for example by reference number 56, and one or more obstacle representations 58. FIG. 5E illustrates how gradient ascent allows escape from non-convex regions in the obstacle. FIG. 5F is a different example from FIG. 5E, in which isosurface tracking allows escape from the non-convex region. However, in FIG. 5F the target isosurface still contains a non-convex region, which the disclosed on-manifold techniques solve. Accordingly, the obstacle boundaries are smoother for higher isosurfaces, representing a simpler problem for the on-manifold terms to resolve.

In considering impenetrability and convergence of shifted boundaries, any trajectory {x}ₜ, that starts outside the convex shifted obstacle boundary (i.e., Γ(x)≥γ>1), and evolves according to dynamics with modulation matrix constructed following equation (8) and (12) and assuming a linear DS with a single attractor at x*∈ [symbol] , will never penetrate the shifted boundary; i.e. Γ({x}ₜ)≥γ, t=0 . . . ∞, and is ensured to converge to the attractor of the linear DS x*.

Care should be taken when selecting tracking level Γ(x)=γ, as conservative selection can lead to disconnected regions, constraining the robot to a subspace of the problem area. Low values can lead to a non-convex manifold at Γ(x)=γ, requiring complex reasoning to ensure circumnavigation of the obstacle. Note that the selected tracking level should be lower than that of the target attractor (i.e., that Γ(x_{f})≤γ).

While the isosurface tracking approach works well for tracking convex isosurfaces from outside the shifted boundary (i.e., when Γ(x)≥γ>1), for non-convex obstacle boundaries modify the system dynamics in the tangent space within the internal boundary region between Γ(x)=γ and Γ(x)=1. The strategy here is to override the dynamics internal to the shifted boundary in order to follow the path of steepest ascent of Γ(x) (i.e., when Γ(x)<γ). When on the shifted boundary (Γ(x)=γ), it is desired that the tangent space dynamics induced by φ(x) to navigate around the obstacle. When far from the obstacle (Γ(x)>γ), it may be useful to pursue behavior similar to the classic modulation strategy. Thus, disclosed herein are three different Λ(x) matrices to accomplish the desired behavior:

$$Λ ( x ) = {Λ}_{∇} ( x ) + {Λ}_{ϕ} ( x ) + {φ}_{Γ} ( x ) {Λ}_{Γ} ( x ) \qquad ( 13 )$$

Λ_{∇}(x) encodes the gradient ascent dynamics, Λ_{φ}(x) the tangent space dynamics, and Λ_{Γ}(x) the classic modulation behavior. Within the boundary, navigating to the target manifold can be accomplished through a modulation matrix of the following form:

$${Λ}_{∇} ( x ) = [ \begin{matrix}1 \\ 0\end{matrix} ] [ φ ( n ) {φ}^{′} ( {e}_{1} ) … {φ}^{′} ( {e}_{d - 1} ) ] {λ}_{11} \qquad ( 14 )$$

$${λ}_{11} = γ ( \frac{1}{γ} - \frac{1}{Γ ( x )} )$$

and φ′(u) are a similar function to φ(u), but are only active internal to the shifted boundary:

$${φ}^{′} ( u ) = \{ \begin{matrix}- 1 & Γ ( x ) < γ ∧ {u}^{T} {\hat{f}}_{g} ( x ) > 0 \\ 1 & Γ ( x ) < γ ∧ {u}^{T} {\hat{f}}_{g} ( x ) < 0 \\ 0 & otherwise\end{matrix} \qquad ( 15 )$$

Λ_{∇}(x) alone will cause the system to track the isosurface at Γ(x)=γ using both normal and tangential velocity components. In relation to convergence to isosurface for gradient ascent, let Γ(x) be defined according to:

$$Γ ( x ) \leq 1 ⇔ x ∈ 𝒪 ( Inside Obstacle ) \qquad ( 16 )$$

$$Γ ( x ) = 1 ⇔ x ∈ \partial 𝒪 ( At Boundary ) \qquad ( 17 )$$

$$∀ α > β , {𝒪}_{𝒶} ⊃ {𝒪}_{β} , ( Monotonic ) \qquad ( 18 )$$

$${𝒪}_{α} = \{ x \vert Γ ( x ) \leq α \} , {𝒪}_{β} = \{ x \vert Γ ( x ) \leq β \} \qquad ( 19 )$$

with C² differentiability and ∥∇Γ(x)∥₂>0∇x∈ [symbol] . A path then exists from every point on Γ(x)=1 to a point on Γ(x)=γ for which Γ(x) is monotonically increasing, and ∥∇Γ(x)∥₂>0. As ∇Γ(x) is smooth (e.g., equations (16)-(19)), this implies that no saddle points or local maxima exist, and that following ∇Γ(x) will lead to the selected isosurface for any point x∈{x:Γ(x)<γ}∩{x:x∈ [symbol] }.

When Γ(x)>γ, only the velocity component in the direction of ∇Γ(x) is scaled (similar to that in the classic modulation). Note that the induced normal velocity is zero on the boundary. To ensure that dynamics emanating from the obstacle are not suppressed, λ₁₁ is augmented with a small value ϵ when n and v are collinear:

$${λ}_{11} = γ ( \frac{1}{γ} - \frac{1}{Γ ( x )} ) + \frac{ϵ \cdot ψ ( 〈 n , v 〉 )}{{Γ ( x )}^{2}} \qquad ( 20 )$$

Note that ϵ is scaled by 1/Γ(x)²; this is a design choice to maintain the properties of the modulation (i.e. that Γ(x)»1⇒M(x)→Π).

However, while Λ_{∇}(x) will ensure convergence to the secondary obstacle boundary, it negates motion in the tangent space of Γ(x) (used alone, the system will come to rest on the boundary of Γ(x)=γ). Here, on-manifold dynamics encoded by φ(x) are utilized. The motivation for φ(x) to be the primary source of system dynamics is based on the merits of tangent-space navigation. Of particular significance is that in dense environments involving non-convex obstacles, the isosurface selected may be lower than one that is explicitly convex, allowing the use of φ(x) as a means to locally navigate around non-convex obstacles while remaining tangential to the isosurface. Accordingly, the tangent space navigation matrix is defined as:

$${Λ}_{ϕ} ( x ) = \frac{1}{1 + {{c}_{γ} ( Γ ( x ) - γ )}^{2}} \cdot diag ( E \cdot ϕ ( x ) ) \frac{1 {v}^{T} H}{{‖ v ‖}_{2}} \qquad ( 21 )$$

Note that this replaces the dynamics v=f_{g}(x) with the tangent space dynamics described by φ(x) when

$$Γ ( x ) = γ , as {v}^{T} {HH}^{T} v = {‖ v ‖}_{2}^{2} ( as {HH}^{T} = {H}^{T} H = 𝕀 ) .$$

c_{γ} is a constant that can be used to control the width of the tracking band (i.e., where dynamics induced by φ(x) are active). This constant should be chosen based on the desired behavior: larger values will only enable on-manifold dynamics, φ(x), when close to the tracking level, Γ(x)=γ.

Finally, to ensure classic modulation further from the obstacle, the regular dynamics matrix are defined as follows:

$${Λ}_{Γ} ( x ) = diag ( [ \begin{matrix}0 & 1 ] ) {C}_{Γ} ( x ) ( 1 + \frac{1}{Γ ( x )} )\end{matrix} \qquad ( 22 )$$

The additional term C_{Γ}(x) acts to smoothly blend the traditional modulation with φ(x) as Γ(x) approaches the target isosurface:

$${C}_{Γ} ( x ) = \frac{{{c}_{γ} ( Γ ( x ) - γ )}^{2}}{1 + {{c}_{γ} ( Γ ( x ) - γ )}^{2}} \qquad ( 23 )$$

Depending upon the desired behavior, Λ_{Γ}(x) can be disabled within the boundary using or φ_{Γ}(x)=Γ(x)>γ. Combining each of these matrices results in the final modulation as follows: Λ(x)=Λ_{∇}(x)+Λ_{φ}(x)+φ_{Γ}(x)Λ_{Γ}(x). This equation illustrates how the effects can be combined by summing the relevant matrices.

This is utilized in standard form: M(x)=H(x)Λ(x)H(x)^{T}. FIGS. 5C-5D demonstrate how the constant cy can be adapted to trade-off gradient ascent and the obstacle exit strategy. Thus the above equations illustrate the modulation technique described herein.

For convergence to attractor for equation (13), let φ(x) represent a consistent, on-manifold direction to a point x′, such that \dot{n}·\dot{v}=1, n=∇Γ(x), v=f_{g}(x). Assume x_{f} is the settling point for the input dynamics (i.e. that

$${x}_{f} = {lim}_{t \to ∞} {\int }_{0}^{t} {f}_{g} ( x ) dt + {x}_{0} ) ,$$

that input dynamics f_{g}(x) are linear, and that Γ(x_{f})>γ. Then, equation (13) preserves the convergence properties of the original system f_{g}(x).

FIGS. 5E-5F demonstrate how the disclosed methodology can be applied to non-convex obstacles, where the selection of an isosurface and use of gradient ascent enables escape from non-convex obstacles, while the obstacle exit strategy can be employed to circumnavigate a non-convex isosurface.

In considering object exit strategies, on-manifold dynamics, through the introduction of off-diagonal elements in the Λ(x) matrix, can enable sophisticated local navigation capabilities. Accordingly, the disclosed obstacle exit strategies can be employed to efficiently circumnavigate both convex and non-convex obstacles. Note that φ(x) operates within the tangent space, requiring any obstacle exit strategy operating in Euclidean space to be transformed to the tangent space. φ(x) is defined as the obstacle exit strategy in Euclidean space that can be transformed to the tangent space by φ′(x)=E^{T} φ(x), accordingly all φ(x) methodologies to produce vectors that are not in the nullspace of E, (i.e. that φ(x)∈ [symbol] (E)⇒|φ(x)·∇Γ(x)|/(∥φ(x)∥₂∥∇Γ(x)∥₂)<1). Accordingly, three obstacle exit strategies are disclosed herein for use in on-manifold circumnavigation. Note that all methodologies assume the attractor position is outside of the shifted boundary

$$( i . e . that Γ ( {x}_{f} ) > γ , {x}_{f} = {lim}_{t \to ∞} {\int }_{0}^{t} {f}_{g} ( x ) dt + {x}_{0} ) .$$

Turning to the Hessian of Γ(x), notated as ∇²Γ(x), said Hessian enables a gradient ascent methodology for circumnavigating non-planar convex isosurfaces. Consider a point of divergence from the obstacle surface; at this point xₜ, the dynamics may satisfy \hat{n}·\hat{v}>0, n=∇Γ(xₜ), v=f_{g}(xₜ). An optimal exit point on the obstacle to be of the following form:

$$C ( x ) = ∇ Γ ( x ) \cdot {f}_{g} ( x ) \qquad ( 24 )$$

In order to maximize equation (24), the gradient can be used as the on-manifold direction, φ(x):

$$ϕ ( x ) = {∇}^{2} Γ ( x ) {f}_{g} ( x ) + ∇ {f}_{g} ( x ) ∇ Γ ( x ) \qquad ( 25 )$$

Function C(x) is assumed to be monotonic along the obstacle surface. This approach can fail with planar surfaces, where ∇²Γ(x) is not full rank, or when ∇Γ(x) and f_{g}(x) are collinear (i.e. requiring a saddle point correction, identical to that in equation (6)), as this represents a stationary point of ∇Γ(x)·f_{g}(x)). In the latter case, this methodology can be easily combined with the approach discussed in relation to the partial on-manifold dynamics and spurious attractors:

$$ϕ ( x ) = {∇}^{2} Γ ( x ) {f}_{g} ( x ) + ∇ {f}_{g} ( x ) ∇ Γ ( x ) + δ \cdot ψ ( 〈 n , v 〉 ) \qquad ( 26 )$$

The disclosed approach will also fail for non-convex isosurfaces, where local maxima in C(x) exist. Note also that this function can cause large velocities when Γ(x) changes rapidly, as is the case for exponentials; as a result, this method requires normalization and consideration for numerical error. The disclosed approach is suitable for convex isosurfaces where det(∇²Γ(x))≠0∀x∈ [symbol] /{x: [symbol] \hat{n},\hat{v} [symbol] =1} (i.e., where there are no inflection points outside of those occurring when ∇Γ(x) and f_{g}(x) are collinear, and the isosurface has some curvature).

For hessian-based obstacle exit strategy convergence, assume det(∇²Γ(x))≠0∀x∈ [symbol] and |f_{g}(x)·∇Γ(x)|≠∥f_{g}(x)∥₂∥∇Γ(x)∥₂, then E^{T}∇²Γ(x)f_{g}(x)≠0. If [symbol] is convex, then the obstacle exit strategy preserves the convergence properties of f_{g}(x).

For a pseudo-hessian/spherical approximation: while use of the Hessian can enable excellent navigation capabilities for convex obstacles, it is sensitive to local maxima in equation (21), which are present in the case of non-convex obstacles (by definition when assuming f_{g}(x) is linear). An extension based on the Hessian approach that can overcome such issues with local maxima involves a relaxation of the manifold to a convex form. For example, consider an approximating manifold described by Γ(x)=(x−r)^{T}(x−r) (i.e., a unit sphere). For this function, the Hessian is ∇²Γ(x)=2·Π.

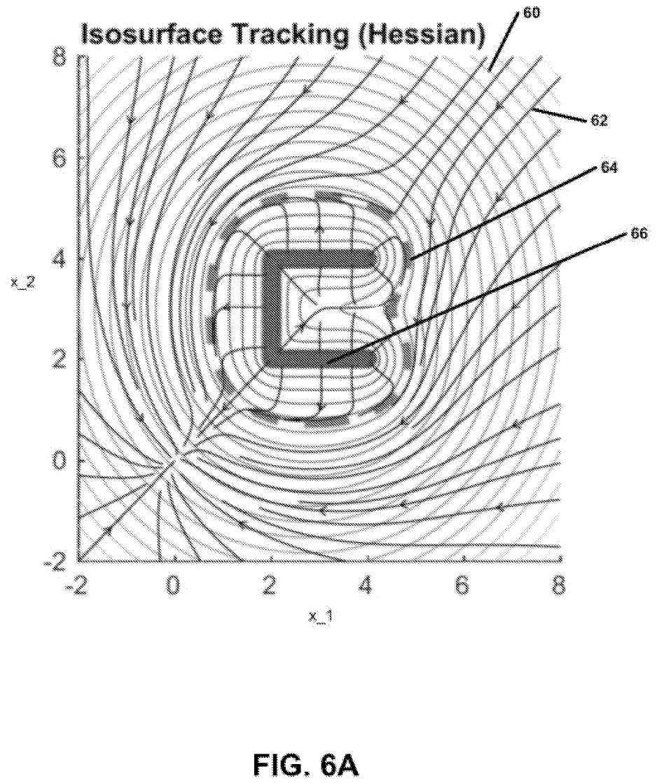

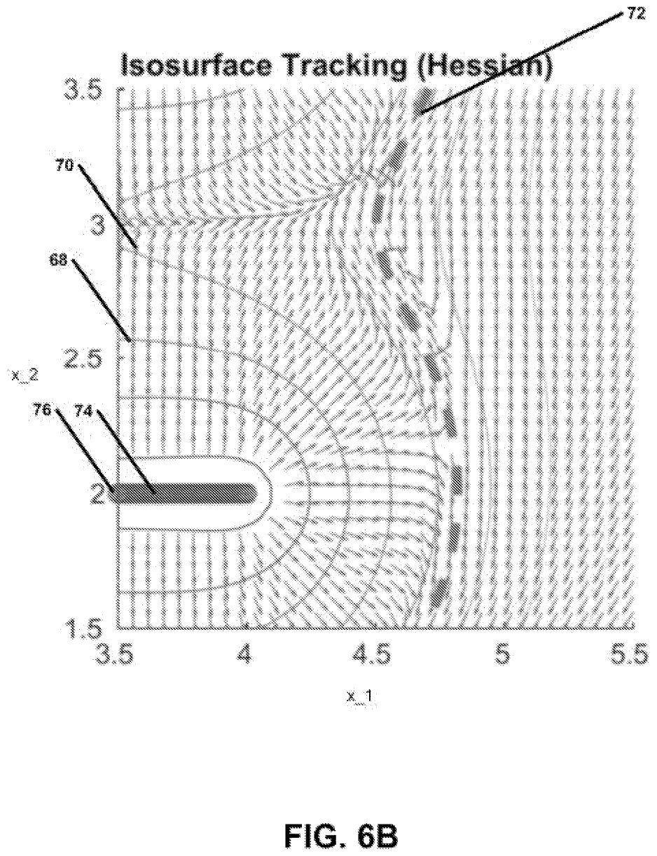

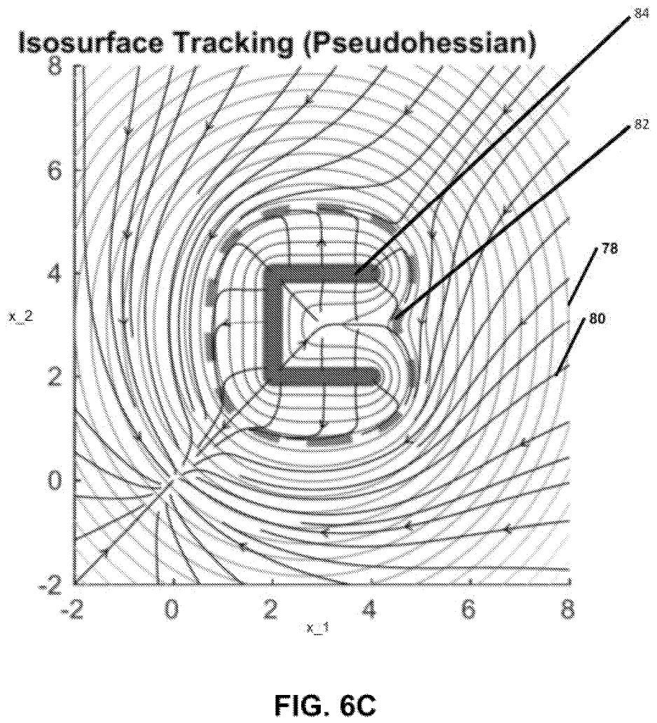

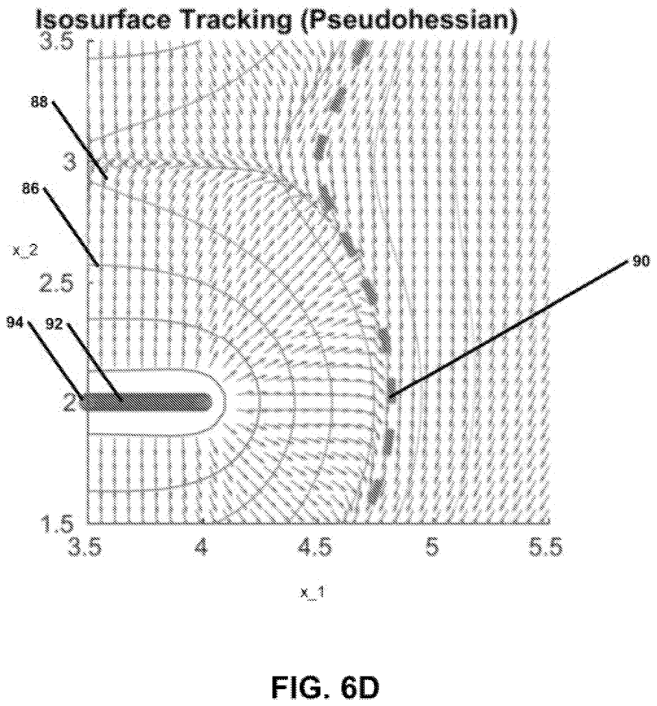

FIGS. 6A-6D depict obstacle exit strategies. The x dimensions are the system state, the axis accordingly is x_1 and x_2. Like reference numbers represent like elements among the several views. FIGS. 6A-D illustrate how tracking a higher order isosurface leads to a simpler planning problem, allowing a variety of techniques to be applied. In this case, as is demonstrated herein, the hessian does not work, as it is still a concave region. However, a pseudohessian does, which is a reinterpretation of the manifold as, say, a sphere. FIGS. 6A-6B contrast the use of a Hessian approach compared to the pseudo-Hessian approach disclosed in relation to FIGS. 6C-6D. In the context of non-convex obstacles, using convex manifold approximations can overcome local minima in Hessian-based obstacle exit strategies.

FIG. 6A is a depiction of isosurface tracking with a standard Hessian on non-convex isosurfaces. Illustrated are isosurfaces of the obstacle distance function, which are given for example by reference numeral 60, and streamlines demonstrating system behavior, which are given for example by reference numeral 62. FIG. 6A includes a target isosurface illustrated by a dashed line, which is given for example by reference number 64, and one or more obstacle representations 66.

FIG. 6B is an alternative depiction of isosurface tracking with a standard Hessian on non-convex isosurfaces. Utilizing a standard Hessian on non-convex isosurfaces can lead to spurious attractors on the isosurface. Illustrated are isosurfaces of the obstacle distance function, which are given for example by reference numeral 60, and streamlines demonstrating system behavior, which are given for example by reference numeral 62. FIG. 6B includes a target isosurface illustrated by a dashed line, which is given for example by reference number 72, and one or more obstacle representations, which are given for example by reference numeral 74. For the obstacle representations, the circles, for example a circle is referred to by reference numeral 76, are points. FIG. 6B illustrates how partial isosurface tracking can be enabled, leading states close to the obstacle to move away from the obstacle and toward the target isosurface 72.

FIG. 6C is a depiction of isosurface tracking with a pseudo-Hessian on non-convex isosurfaces. Illustrated are isosurfaces of the obstacle distance function, which are given for example by reference numeral 78, and streamlines demonstrating system behavior, which are given for example by reference numeral 80. FIG. 6A includes a target isosurface illustrated by a dashed line, which is given for example by reference number 82, and one or more obstacle representations 84.

FIG. 6D is an alternative depiction of isosurface tracking with a pseudo-Hessian on non-convex isosurfaces. Illustrated are isosurfaces of the obstacle distance function, which are given for example by reference numeral 86, and streamlines demonstrating system behavior, which are given for example by reference numeral 88. FIG. 6D includes a target isosurface illustrated by a dashed line, which is given for example by reference number 90, and one or more obstacle representations, which are given for example by reference numeral 92. For the obstacle representations, the circles, for example a circle is referred to by reference numeral 94, are points. Using a pseudo-Hessian (assuming a spherical isosurface) on nonconvex isosurfaces can overcome spurious attractors on the isosurface.

Using the Hessian of the spherical approximation of the isosurface can improve navigation performance on manifolds with small concave regions, as illustrated in FIG. 6C-D. However, the approximating manifold may be close in form to that of the original isosurface in order to be effective, as the resulting velocity from φ(x) preferably should not be within the nullspace of E. This method is particularly effective when the selected isosurface is further away from the obstacle.

Accordingly, for pseudo-Hessian-based obstacle exit strategy convergence, it can be assumed that non-convex isosurface Γ(x)=γ can be approximated by function Γ′(x), where Γ′(x) is a convex isosurface. If ∇²Γ′(x)f_{g}(x)∈ [symbol] (E_{Γ})∀x∈{x: Γ(x)=γ}, the obstacle exit strategy preserves the convergence properties of f_{g}(x).

Turning now to the geodesic approximation, the geodesic approximation technique can be used in the context of non-convex obstacles to seek the shortest path for circumventing an obstacle. The geodesic approximation is a simple strategy for overcoming the limitations of the Hessian inspired approaches is to sample a straight, short line on the manifold over a set of predetermined directions and then select the direction that minimizes the potential along the path with regard to the attractor (i.e., the direction that minimizes

$${\int }_{{x}_{0}}^{{x}_{f}} {‖ {f}_{g} ( x ) ‖}_{2} d x$$

along a straight line on the obstacle manifold).

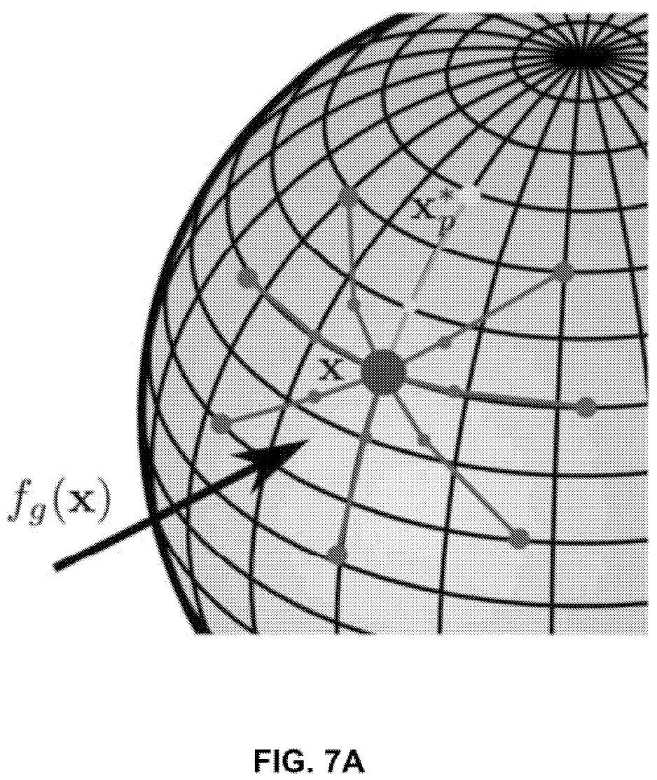

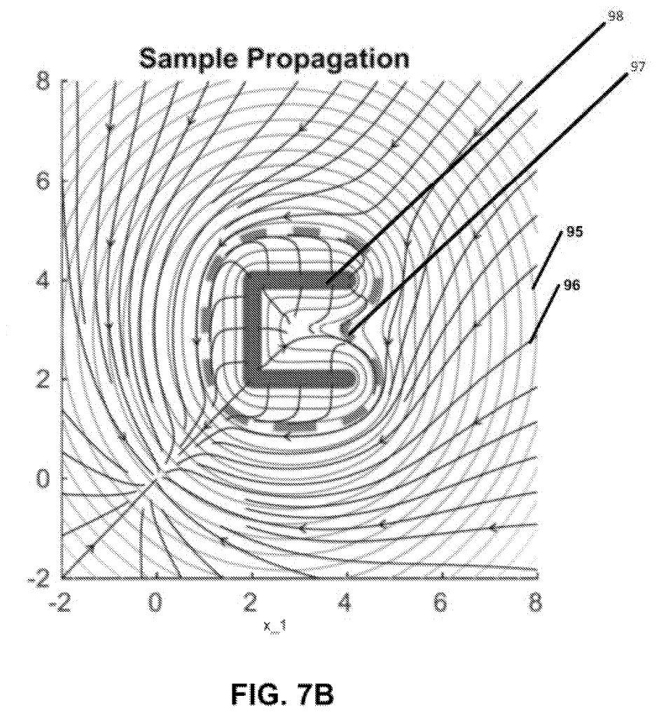

The geodesic approximation approach is illustrated in FIGS. 7A-7B. FIG. 7A is a depiction of the geodesic approximation, wherein samples are propagated in fixed directions at a fixed depth. FIG. 7B is a streamslice view of the geodesic approximation technique applied to a non-convex obstacle. The x dimensions are the system state, the axis accordingly is x_1 and x_2. Illustrated are isosurfaces of the obstacle distance function, which are given for example by reference numeral 95, and streamlines demonstrating system behavior, which are given for example by reference numeral 96. FIG. 7B includes a target isosurface illustrated by a dashed line, which is given for example by reference number 97, and one or more obstacle representations 98. The streamlines illustrate the path that the system will follow (i.e. if the system were initialized on the line it would continue to follow it).

Let u₀ be a candidate direction in [symbol] , subject to u₀∈ [symbol] (E(x)). Accordingly, a line X=[x₀ x₁ . . . x_{f}] is constructed along an isosurface with associated potential, ρ(X,u), using the following, where a is a constant that regulates step size:

$${x}_{i + 1} = α \cdot E ( {x}_{i} ) {E ( {x}_{i} )}^{T} {u}_{i} + {x}_{i} \qquad ( 27 )$$

$${u}_{i + 1} = \frac{E ( K ) {E ( K )}^{T} {u}_{i}}{{‖ E ( {x}_{t} ) {E ( {x}_{t} )}^{T} {u}_{i} ‖}_{2}} \qquad ( 28 )$$

$${p}_{i + 1} = {p}_{i} + α \cdot {‖ {f}_{g} ( {x}_{i + 1} ) ‖}_{2} \qquad ( 29 )$$

This method utilizes a first order approximation to the obstacle surface; as such, it does not strictly find a path on the isosurface, but closely approximates one for appropriate α. The obstacle isosurface is a lower dimensional subspace of [symbol] , which is treated as a locally Euclidean space in [symbol] . For [symbol] , the manifold is one dimensional, allowing for u₀ to be selected as ±1; for [symbol] the tangent space of the manifold is two dimensional, from which sixteen directions are constructed based on the basis vectors e₁ and e₂. For notational simplicity, the number of paths are referred to as M. The sampling of these directions is a design consideration, herein sixteen linearly spaced search directions described by

$${u}^{( i )} = sin ( \frac{π}{4} \cdot i ) {e}_{1} + cos ( π / 4 \cdot i ) {e}_{2}$$

are used. This method can be trivially extended to enable different sampling strategies.

In the general application of this algorithm, the direction associated with the lowest potential is selected as input to φ(x). However, care may be taken with both the step size α, and number of steps N. If N or α are too large, wrapping or over extension can occur, leading to both unnecessary computation and inaccurate approximations, while values that are too small can lead to local minima. As such, search directions benefit from termination criteria, or careful calibration to ensure that both N and α are appropriate in the context of the obstacles they are being used to circumnavigate.

The disclosed implementation of this algorithm includes an optional gradient descent phase, where the start position for sample calculation, x₀, is projected onto the obstacle isosurface to be tracked

$$( i . e . {x}_{0}^{′} s . t . Γ ( {x}_{0}^{′} ) = {γ}_{c} ) .$$

This can result in more consistent behavior for two reasons: first the obstacle manifold maintains a consistent size; secondly, it maintains a consistent shape—a highly relevant fact when multiple obstacles are under consideration, as higher isosurfaces can encompass multiple obstacles, leading to inconsistent behavior of this method over changing isosurfaces.

The introduction of termination criteria can also provide a level of consistency and generalizability, while improving computation times. For closed isosurfaces in 2D, the termination criteria is considered to be where ∇Γ(x)·f_{g}(x) is at a maximum or greater than a threshold and where ∥f_{g}(x)∥₂<∥f_{g}(x₀)∥₂. Concave or highly irregular isosurfaces may result in points on the obstacle manifold that maximize ∇Γ(x)·f_{g}(x), but where ∥f_{g}(x)∥₂>∥f_{g}(x₀)∥₂. This can induce limit cycles, breaking convergence guarantees. For isosurfaces in 2D that are not closed (e.g. Γ(x)=exp(∥diag([0 1])x∥₂), representing the line y=0), the criterion still applies in a single direction, resulting in lower potential in that direction.

For obstacles in [symbol] , d>2, it is not guaranteed that any set of candidate paths describing a straight line on the manifold will satisfy the termination criteria outlined above (i.e. the optimal path will only be guaranteed when the number of paths M→∞). To increase the chance of reaching the termination condition, search directions are bias towards maximizing f_{g}(x)·∇Γ(x) by including the derivative in the search direction when in proximity to a maximum. Note that this modifies the search direction update as follows:

$${u}_{i + 1} = ( 1 - {σ}_{z} ) {u}_{i} + {σ}_{z} ∇ g ( x ) \qquad ( 30 )$$

$${σ}_{z} = max ( 0 , {( \hat{g} ( x ) )}^{z} ) \qquad ( 31 )$$

$$g ( x ) = ∇ Γ ( x ) \cdot {f}_{g} ( x ) \qquad ( 32 )$$

$$∇ g ( x ) = {∇}^{2} Γ ( x ) \cdot {f}_{g} ( x ) + ∇ {f}_{g} ( x ) \cdot ∇ Γ ( x ) \qquad ( 33 )$$

z∈ [symbol] is a scaling power that controls the effect (i.e., z→∞⇒σ_{z}(g(x))→δ(g(x)−1)). While this method does not guarantee convergence for any obstacle, it can increase performance by biasing each sample to a point of termination at the expense of increased computation time. Hessian calculations for sample based obstacles can incur significant computational expense, particularly when the exponential field is used.

The termination criteria may fail for nonlinear f_{g}(x). An advantage of this algorithm is that it runs in constant time (making it suitable for a real-time system), is easily parallelized for multiple search directions, and can provide near-optimal behavior with appropriate parameters. For the geodesic approximation exit strategy convergence, let [symbol] be a closed, smooth, manifold on {Γ(x)=γ: x∈ [symbol] }. Then, for α«1, N→∞, M→∞, this obstacle exit strategy will converge to the path of minimum potential and preserve the convergence properties of f_{g}(x). This follows from α«1 and [symbol] ≈EE^{T}u. All modulation strategies discussed herein assume a single function Γ(x) that can represent the boundaries of arbitrarily shaped obstacles, under the further assumption that such functions follow equations (16)-(19).

Process 200 applies the modulation matrix to the input dynamics in block 260. Accordingly, the DS is modulated via the modulation matrix to direct the DS towards a target position. The modulation may or may not be applied to the input dynamics based upon the sensor data. Additionally, process 200 may check for the wake effect.

Equations used to form the modulation matrix include: an equation to describe the gradient ascent; an equation to describe embedding on-manifold dynamics; and an equation to ensure classic modulation behavior remains in effect. Describing gradient ascent may include navigating the obstacle boundary from within, meaning retreating from the obstacle. Embedding on-manifold dynamics may include using the geodesic approximation within the modulation approach. Ensuring classic modulation behavior remains in effect may include ensuring that on-manifold dynamics only affect the modulation when close to the obstacle boundary. Thus, navigating to a target manifold can be accomplished through the modulation matrix.

Process 200 provides the determined dynamics to the automated system in block 270. The determined dynamics, which may refer to the modulated dynamics, are sent in the form of control signals provided to an autonomous system.

FIG. 8 is a flow diagram of a process 300 for processing sensor data for an autonomous system control. Process 300 may, for example, be similar to or the same as a process used to process data to control an autonomous system (i.e., a DS), such as the autonomous system 130 described above in conjunction with FIG. 1B.

In process 300, the sensor data is processed to generate or update a gamma function. The generation may include forming or updating the gamma function. The gamma function may include information about the obstacles in the environment, non-obstacle information about the environment, or a mix of the two. The gamma functions may be sample-based representations or projection-based representations of obstacles. Process 300 combines two or more gamma functions (be they sample-based representations or projection-based representations of obstacles) into a single differentiable function. Accordingly, any number of sample-based or projection-based obstacles may be combined into a single representation.

Process 300 receives the sensor data in block 310. The sensor data is the information used by the system to build the obstacle representations. The sensor data describes or represents the environment (such as environment 102 in FIG. 1B) to the collision avoidance system (such as CAS 134 in FIG. 1B). Further, the sensor data describes or represents information corresponding to or indicative of obstacle locations to the CAS.

Process 300 calculates obstacle representations in block 320. The obstacle representations may be a sample-based representation and/or a projection-based representation. Accordingly, in order to calculate the obstacle representations, process 300 calculates sample-based obstacle representations in block 322 and/or calculates projection-based obstacle representations in block 324. As the obstacle representation may be a sample-based representation or a projection-based representation, either or both of the sample-based representation and the projection-based representation may be calculated.

Ideal obstacle representations should allow for arbitrary representation of surfaces, paths, and boundaries. For example, the sample-based approach enables representation of arbitrarily complex obstacles, while the projection-based method allows efficient representation of mathematically simple surfaces, such as planes, cylinders, and ellipsoids. Disclosed herein are explicit equations for the [symbol] differentiable obstacle representation functions, along with associated closed-form derivates and Hessians.

To calculate the sample-based obstacle representations in block 322, a gamma field function is calculated. The sample-based gamma function uses field functions, while the projection-based gamma function does not. The gamma field function describes a singular sample point in the gamma function that defines a sample obstacle. In comparison, the gamma function describes the collection of data points (as a composite of the gamma field functions).

In order to calculate the sample-based obstacle representations in block 322, process 300: first, calculates or otherwise determines the first gamma field function and a derivative of the first gamma field function in block 322a; and second, calculates a second gamma field function and a derivative of the second gamma field function on selected representation and parameters in block 322b.

The first gamma field function and derivative of the first gamma field function are calculated or otherwise determined based upon a selected field representation and parameters. The field is a description of a sample point, which may be in the form of a quadratic or exponential obstacle field. The field can be used to induce different modulation effects by changing the rate at which the function increases. The field may be used to describe an obstacle field.

The second gamma field function and second gamma field function derivative are calculated or otherwise determined based upon a selected field representation and parameters. The second gamma function may be another sample point. The second gamma function may represent multiple obstacles or sensor-based representations. Accordingly, the process steps through each point and calculates a gamma field value for that point.

Sample-based obstacle representations may be used for the purpose of representing complex, non-convex surfaces. Consider a bounded region described by the continuous function ƒ(τ): [symbol] → [symbol] , τ∈[τₘᵢₙ, τₘₐₓ], alongside boundary function s(τ): [symbol] → [symbol] which describes the boundary of the obstacle relative to the bounded region ƒ(τ), such that ∀u: ∥u∥₂=1, ∥ƒ(τ)+s(τ)·u∥₂=1⇒Γ(x)=1 (i.e., that Γ(x)=1 on the boundary).

A description of the sample point may be defined as an obstacle field Γ_{f}. An obstacle field Γ_{f} may defined as Γ_{f}(x,τ): [symbol] × [symbol] → [symbol] as a description of the sample point. Described below are both a quadratic and exponential obstacle field which can be used to induce different modulation effects by changing the rate at which the function Γ(x) increases.

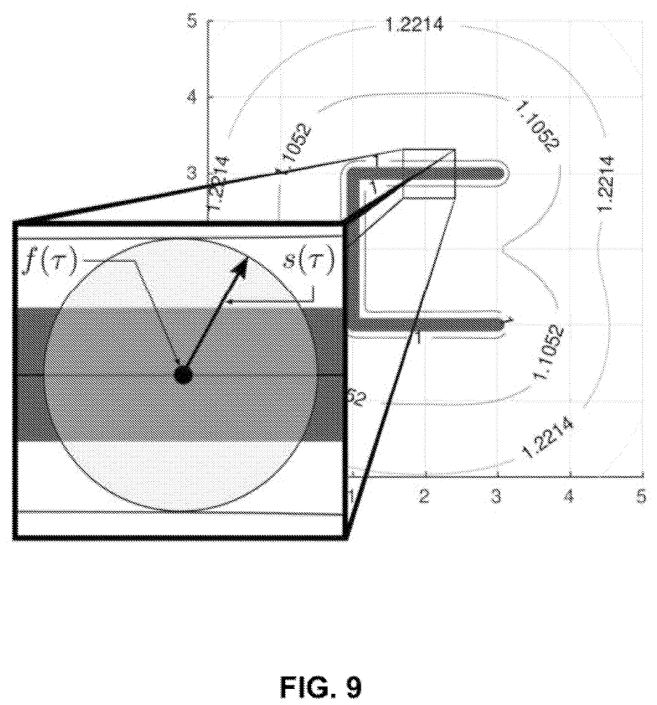

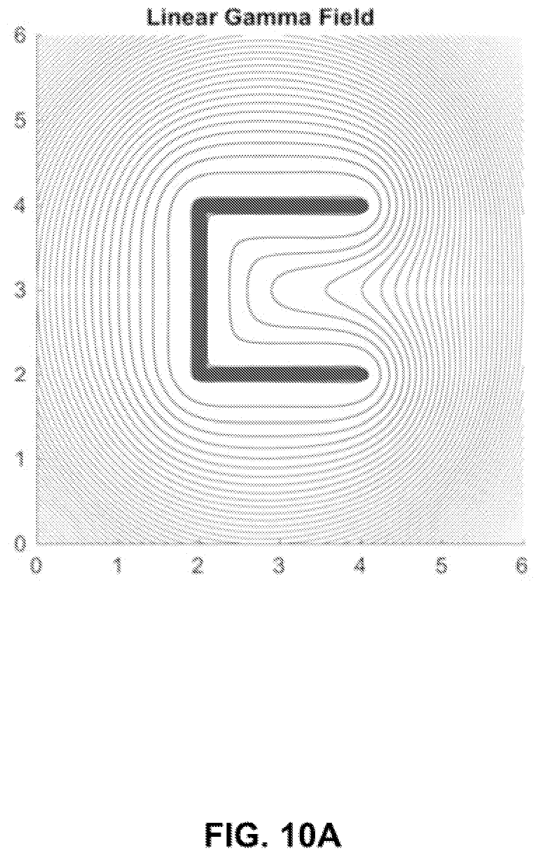

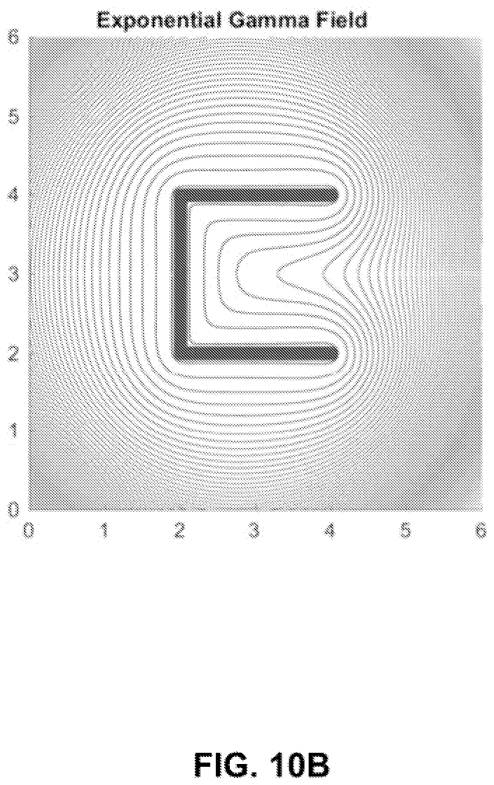

The notation is illustrated in FIG. 9, while the effect of using either a quadratic or an exponential obstacle field can be seen in FIGS. 10A-10B.

FIG. 9 thus illustrates notation for sample-based obstacle representations where ƒ(τ) is a continuous function describing a path representation of the obstacle. The associated offset, s(τ) defines the width of the Γ(x)=1 boundary.

The quadratic obstacle field can be constructed as follows:

$${Γ}_{f} ( x , τ ) = α ( {‖ x - f ( τ ) ‖}_{2}^{2} - {s ( τ )}^{2} ) + 1 \qquad ( 34 )$$

$$∇ {Γ}_{f} ( x , τ ) = 2 \cdot α \cdot ( x - f ( τ ) ) \qquad ( 35 )$$

$${∇}^{2} {Γ}_{f} ( x , τ ) = 2 \cdot α \cdot 𝕀 \qquad ( 36 )$$

FIGS. 10A-10B illustrate comparisons of the linear and exponential gamma fields. FIG. 10A is a depiction of a linear gamma field. FIG. 10B is a depiction of an exponential gamma field. Quadratic and exponential gamma fields show similar levels when close to the obstacle boundary, but differ when far from the obstacle. Exponential fields are often a more appropriate choice in dense environments since exponential fields enable both a rapid onset of modulation (which are considered to “kick-in” at Γ(x)≈30 when using standard Λ(x) matrices) and slow growth when close to the boundary. FIGS. 10A and 10B illustrate the effects of the different obstacle representations. This leads to changes in robot behavior based on how the gamma value increases.

The exponential field can be constructed using the following equations. Note ƒ(x)=x−ƒ(τ), ∥ƒ(x)∥₂=∥x−ƒ(τ)∥₂, and ∥ƒ(x)∥ₛ=(∥x−ƒ(τ)∥₂−s(τ)) are introduced to ease notation:

$${Γ}_{f} ( x , τ ) = exp ( α \cdot {‖ f ( x ) ‖}_{s}^{m} ) \qquad ( 37 )$$

$$∇ {Γ}_{f} ( x , τ ) = α \cdot m \cdot {‖ f ( x ) ‖}_{s}^{m - 1} \cdot \frac{f ( x )}{{‖ f ( x ) ‖}_{2}} \cdot {Γ}_{f} ( x , τ ) \\ {∇}^{2} {Γ}_{f} ( x , τ ) = α \cdot m \cdot {Γ}_{f} ( x , τ ) \frac{{‖ f ( x ) ‖}_{s}^{m - 2}}{{‖ f ( x ) ‖}_{2}^{2}} \qquad ( 38 )$$

$$( ζ \cdot f ( x ) {f ( x )}^{T} + {‖ f ( x ) ‖}_{s} {‖ f ( x ) ‖}_{2} \cdot 𝕀 ) \qquad ( 39 )$$

$$ζ ( x , τ ) = ( m - 1 ) + α \cdot m \cdot {‖ f ( x ) ‖}_{s} \cdot {( α \cdot ‖ f ( x ) {‖}_{2} - s ( τ ) )}^{m - 1} - \frac{{‖ f ( x ) ‖}_{s}}{{‖ f ( x ) ‖}_{2}} \qquad ( 40 )$$

ζ is an additional term in the calculation. Π is an identity matrix. Every point in obstacle field ƒ(τ) exerts a degree of influence similar to or the same to that of a spherical obstacle, while the points in the field are infinitesimally close. The boundary of the field, where Γ_{f}(x,τ)=1, can be directly controlled through parameter s(τ), while field scaling can be controlled via the weighting parameter and the power to which the distance is raised (α and m, respectively).

The obstacle field may be integrated into a single obstacle representation that preserves the boundary of Γ_{f}(x,τ)=1. Accordingly, the following differentiable minimum function is used to construct Γ_{∇}(x):

$${Γ}_{∇} ( x ) = - \frac{1}{ρ} log ( {\int }_{τ} exp ( - ρ \cdot {Γ}_{f} ( x , τ ) ) d τ ) \qquad ( 41 )$$

Evaluating such an integral may yield an approach that is impractical for the user, particularly for more complex fields involving surfaces or sample data. Instead, a sampling-based approach to obstacle representation is utilized through \hat{Γ}_{∇}(x) with a sample size of s. This function has the property that lim_{s→∞}\hat{Γ}_{∇}(x)=Γ_{∇}(x) when uniform sampling is employed for τ:

$${\hat{Γ}}_{∇} ( x ) = - \frac{1}{ρ} log ( {\sum }_{τ} exp ( - ρ \cdot {Γ}_{f} ( x , τ ) ) ) \qquad ( 42 )$$

$$∇ {\hat{Γ}}_{∇} ( x ) = \frac{{\sum }_{τ} exp ( - ρ \cdot {Γ}_{f} ( x , τ ) ) \cdot ∇ {Γ}_{f} ( x , τ )}{{\sum }_{τ} exp ( - ρ \cdot {Γ}_{f} ( x , τ ) )} \qquad ( 43 )$$

$${∇}^{2} {\hat{Γ}}_{∇} ( x ) = \frac{1}{\sum w ( x , τ )} ( {\sum }_{τ} ζ ( x , τ ) - ( {\sum }_{τ} ∇ w ( x , τ ) ) ∇ {{\hat{Γ}}_{∇} ( x )}^{T} ) \qquad ( 44 )$$

$$ζ ( τ , x ) = ( ∇ w ( x , τ ) \cdot ∇ {{Γ}_{f} ( x , τ )}^{T} + w ( x , τ ) \cdot {∇}^{2} {Γ}_{f} ( x , τ ) ) \qquad ( 45 )$$

$$w ( x , τ ) = exp ( - ρ \cdot {Γ}_{f} ( x , τ ) ) \qquad ( 46 )$$

$$∇ w ( x , τ ) = - w ( x , τ ) ρ ∇ {Γ}_{f} ( x , τ ) \qquad ( 47 )$$

While this approach allows statistical approximation to min_{τ} Γ_{f}(x,τ), \hat{Γ}_{∇}(x) is sensitive to parameter ρ and can lead to non-convex obstacle boundaries for a small number of samples, as well as sharp ridges in the gradient of Γ(x). To smooth both the obstacle boundary and the gradient while removing dependence upon ρ, an approximation is introduced based on

$${‖ x - {f ( τ )}^{n} ‖}_{2}^{n} ;$$

this resolves to a weighted approach for power n, defined as Γₙ(x).

$${Γ}_{n} ( x ) = \frac{{\sum }_{τ} {α}_{n} ( x , τ ) {Γ}_{f} ( x , τ )}{{\sum }_{τ} {α}_{n} ( x , τ )} = \frac{ρ ( x )}{β ( x )} \qquad ( 48 )$$

$$∇ {Γ}_{n} ( x ) = \frac{β ( x ) ∇ ρ ( x ) - ρ ( x ) ∇ β ( x )}{{β ( x )}^{2}} \qquad ( 49 )$$

$$∇ β ( x ) = {\sum }_{τ} ∇ {a}_{n} ( x , τ ) \qquad ( 50 )$$

$$∇ ρ ( x ) = {\sum }_{τ} ( {α}_{n} ( x , τ ) ∇ {Γ}_{f} ( x , τ ) + {Γ}_{f} ( x , τ ) ∇ {a}_{n} ( x , τ ) ) \qquad ( 51 )$$

$${∇}^{2} {Γ}_{n} ( x ) = \frac{1}{β ( x )} ( {∇}^{2} ρ ( x ) - ∇ {Γ}_{n} ( x ) ∇ {β ( x )}^{T} - ∇ β ( x ) ∇ {{Γ}_{n} ( x )}^{T} - Γ ( x ) {∇}^{2} β ( x ) ) \qquad ( 52 )$$

$${∇}^{2} ρ ( x ) = {\sum }_{τ} ( ∇ {Γ}_{f} ( x , τ ) ∇ {{α}_{n} ( x , τ )}^{T} + {α}_{n} ( x , τ ) \cdot {∇}^{2} {Γ}_{f} ( x , τ ) + ∇ {α}_{n} ( x , τ ) ∇ {{Γ}_{f} ( x , τ )}^{T} + {Γ}_{f} ( x , τ ) {∇}^{2} {α}_{n} ( x , τ ) ) \qquad ( 53 )$$

$${∇}^{2} β ( x ) = {\sum }_{τ} {∇}^{2} α ( x , τ ) \qquad ( 54 )$$

Weights are based on powers of distances to the sample points of the obstacle, ƒ(τ):

$${α}_{n} ( x , τ ) = \frac{1}{{‖ x - f ( τ ) ‖}_{2}^{n}} \qquad ( 55 )$$

$$∇ {α}_{n} ( x , τ ) = \frac{- n ( x - f ( τ ) )}{{‖ x - f ( τ ) ‖}_{2}^{( n + 2 )}} \qquad ( 56 )$$

$${∇}^{2} {α}_{n} ( x , τ ) = \frac{- n}{{‖ x - f ( τ ) ‖}_{2}^{( n + 2 )}} ( 𝕀 - \frac{n + 2}{{‖ x - f ( τ ) ‖}_{2}^{2}} ( x - f ( τ ) ) {( x - f ( τ ) )}^{T} ) \qquad ( 57 )$$

The weights produce an effect analogous to the differentiable minimum as power increases.

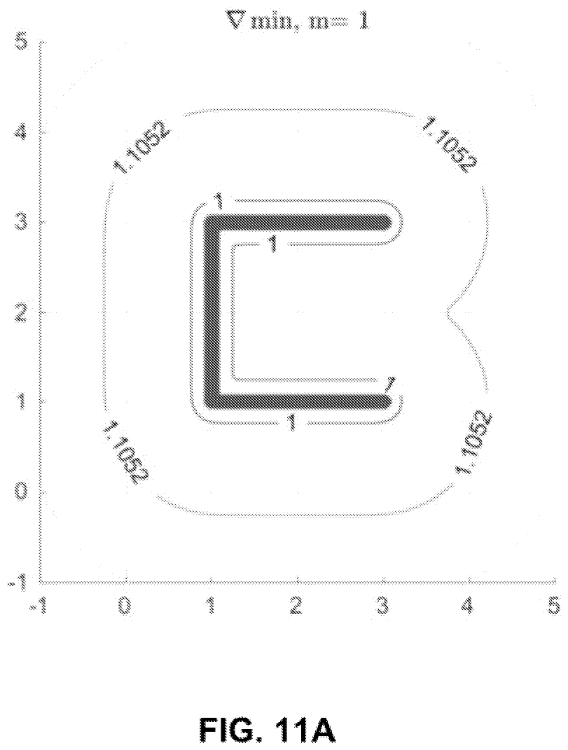

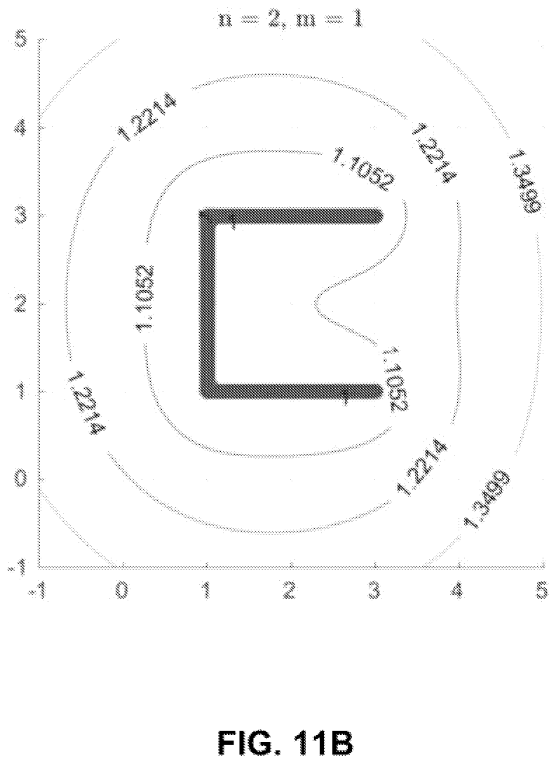

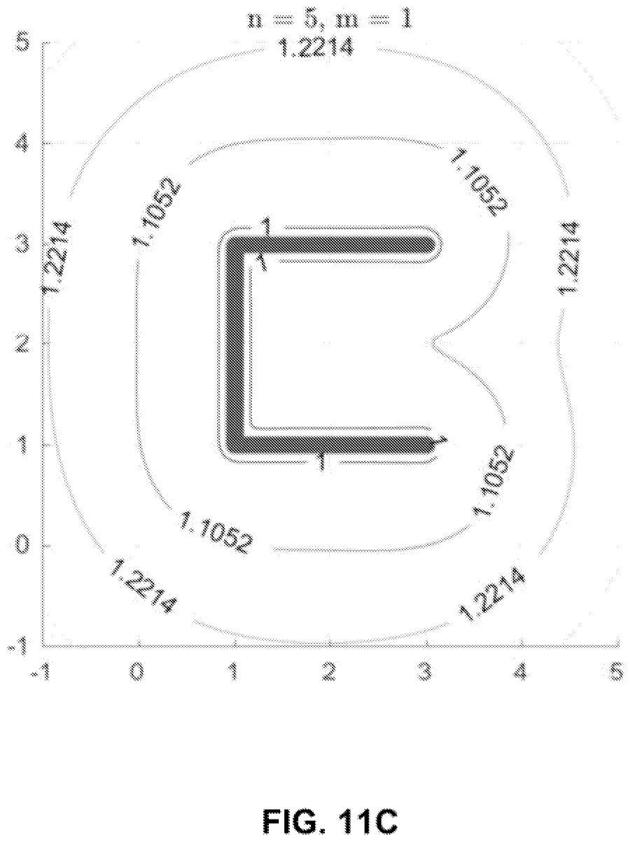

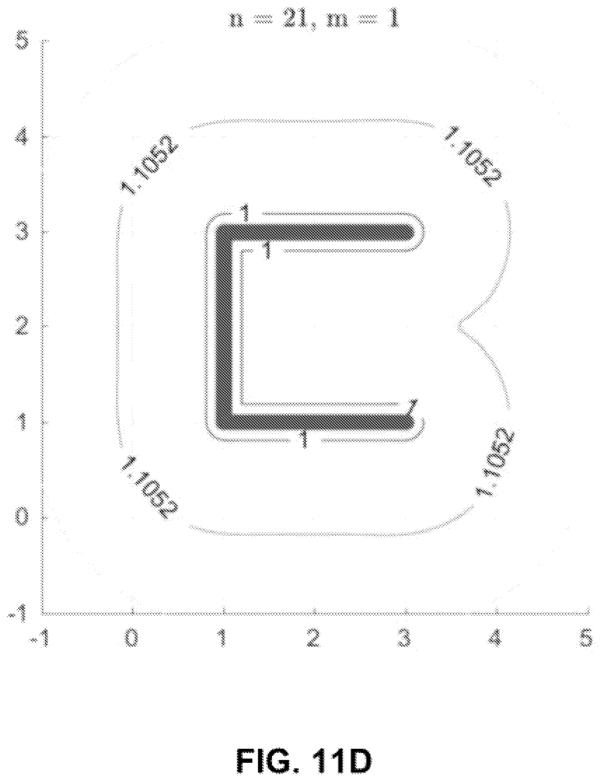

FIGS. 11A-11D illustrates this effect for various powers, demonstrating how the function converges to the differentiable minimum function as the power n increases. In practice, lower n-values ensure a smooth gradient stemming from the obstacle, a property leveraged as discussed above to cause the system to generate motions that can escape from non-convex regions when close to the obstacle boundary.

FIGS. 11A-11D illustrate the effect of increasing powers on minimum approximation. FIG. 11A illustrates an object, wherein ∇ is at a minimum and m=1. FIG. 11B illustrates an object, wherein n=2 and m=1. FIG. 11C illustrates an object, wherein n=5 and m=1. FIG. 11D illustrates an object, wherein n=21 and m=1. As the power of n in αₙ increases, the function more closely approximates that produced by the differentiable minimum. The advantage of lower n-values is a smoother gradient, which leads to smoother modulation when navigating away from the obstacle.

Care should be taken to ensure that s(τ) and the sample size are chosen such that equation (19) remains true for Γ(x)>1 (i.e., that ∂ [symbol] : Γ(x)=1 is closed). The calculation of both Γ(x) and ∇Γ(x) have a complexity of O(s), where s represents the number of samples. The disclosed method operates without parallelization, with s<10k to achieve real-time (meaning less than 1 ms) performance, ensuring the computationally efficient criteria are met. However, this approach remains highly amenable to GPU acceleration, potentially allowing for much larger sample sizes. This representation is applicable to both complex surfaces and pointclouds.

To calculate the projection-based obstacle representations in block 324, a gamma field function is calculated. While the sample based representations enable arbitrary representation of complex obstacles, said representations can prove inefficient for representing large, relatively simple surfaces, such as the boundaries of a robot's reach or the surface upon which the robot operates. According, a projection based obstacle representation is disclosed herein using projections and normal equations.

Consider an obstacle representation based on projection matrix P, center r, and offset s:

$$Γ ( x ) = exp ( α \cdot ( {‖ P ( x - r ) ‖}_{2} - s ) ) \qquad ( 58 )$$

The gradient and Hessian of this function can be shown as the following:

$$∇ Γ ( x ) = α \cdot \frac{Γ ( x )}{{‖ P ( x - r ) ‖}_{2}} {P}^{T} P ( x - r ) \qquad ( 59 )$$

$${∇}^{2} Γ ( x ) = α \cdot \frac{Γ ( x )}{{‖ P ( x - r ) ‖}_{2}} ( {P}^{T} P + ( \frac{α}{{‖ P ( x - r ) ‖}_{2}} - \frac{1}{{‖ P ( x - r ) ‖}_{2}^{2}} ) {P}^{T} P ( x - r ) {( x - r )}^{T} {P}^{T} P \qquad ( 60 )$$

For a flat surface (e.g., a table, or wall), the obstacle can be parameterized with normal n and c(x)=Pc, where c is a point on the surface. The projection in such a case can be constructed as follows:

$$P = \frac{n {n}^{T}}{{n}^{T} n} \qquad ( 61 )$$

A cylindrical obstacle representation is also easily represented for a given center r, using a cylindrical projection P. For example, a vertical cylindrical projection function takes the following form:

$$P x = [ \begin{matrix}1 & 0 & 0 \\ 0 & 1 & 0 \\ 0 & 0 & 0\end{matrix} ] x = [ \begin{matrix}x \\ y \\ 0\end{matrix} ]$$

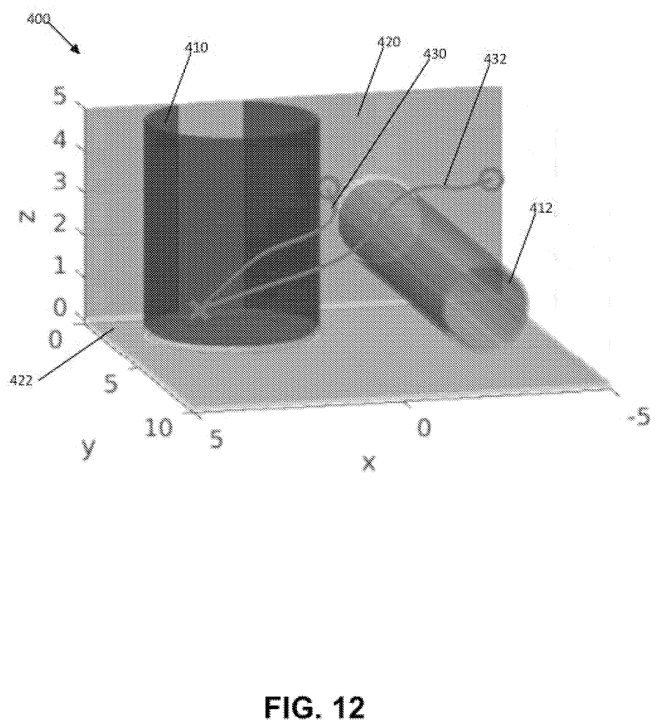

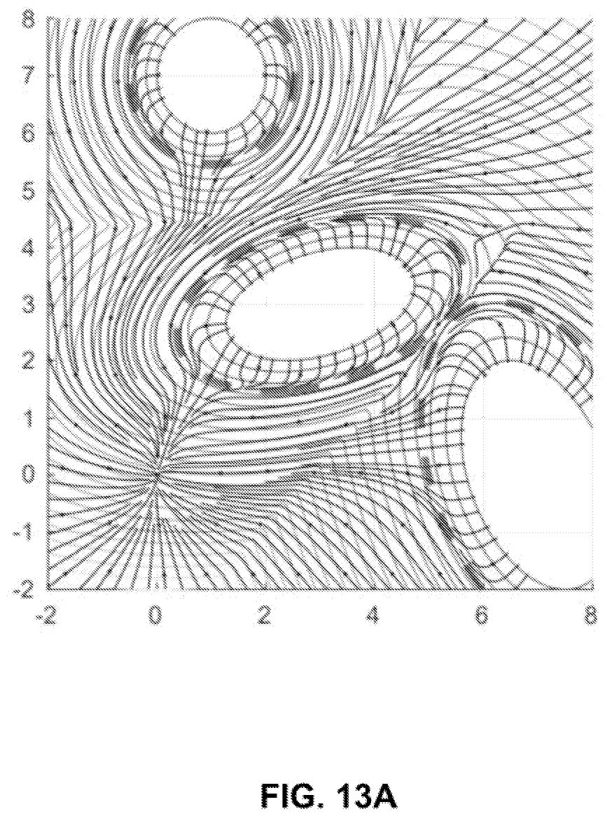

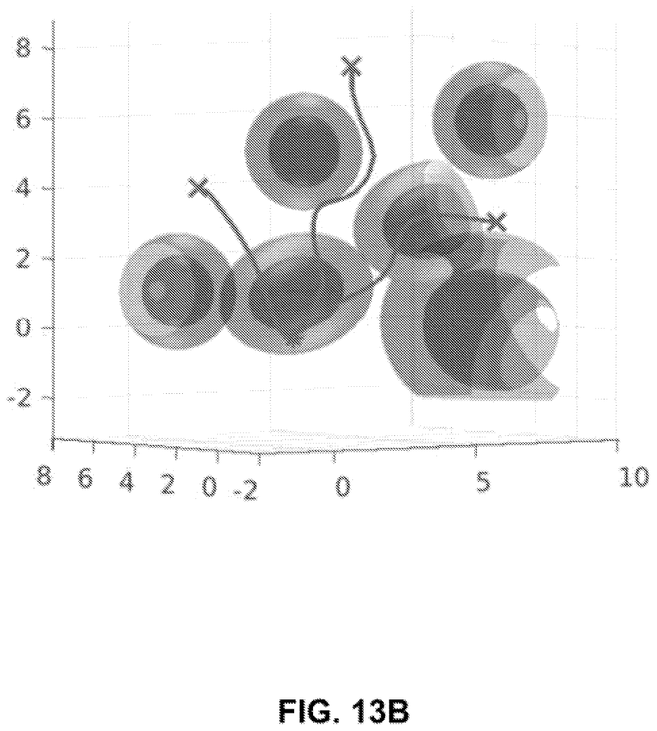

This format is also amenable to ellipsoidal objects, or for representing uncertainty about an obstacle. In the latter case, for obstacles with Gaussian uncertainty (as described by mean μ, and covariance Σ), this can be accomplished using the Cholesky decomposition of the information matrix, P=chol(Σ⁻¹), c_{dist}=1 for the 1−σ bound, and r=μ. Used thusly, the boundary of the obstacle will be at the 1−σ bound. FIG. 12 depicts examples of both cylindrical and planar obstacles, while FIGS. 13A-13B shows an example of the covariance obstacle.

FIG. 12 is a depiction of various projection based obstacles 400. Specifically, FIG. 12 depicts two cylindrical obstacles, including a first cylindrical obstacle 410 and a second cylindrical obstacle 412, and two planar obstacles, including a first planar obstacle 420 and a second planar obstacle 422, in orthogonal orientations. A first line 430 and a second line 432 represent two examples of the automated system successfully navigating around these obstacles. The simulations were performed using RK4, with Δt=1 ms.

FIG. 13A is a depiction of a covariance obstacle in two dimensions (2D), which is illustrated as a streamslice view. FIG. 13B is a depiction of a covariance obstacle in three dimensions (3D), including several RK4 simulations. The Isosurfaces shown in 3D are for Γ(x)={1, 1.4}. The explicit representation of uncertainty ensures that modulated dynamical systems never penetrate the uncertainty region.

Process 300 combines the gamma functions in block 330 into a single differentiable gamma function. Any number of gamma functions (be they gamma functions for sample-based or projection-based obstacles) can be combined into a single differentiable function. For the sample-based obstacle representation, the gamma field values for each point may be combined into a (single) gamma function, if there are multiple obstacles or sensor-based representations, these are then combined into a single function. The sample-based gamma functions that may be combined include: the first gamma field function; the derivative of the first gamma field function; the second gamma field function; and the derivative of the second gamma field function. Once combined, the gamma function for the sample-based representation is combined with the projection-based gamma function. Accordingly, multiple obstacles representations (sample-based and/or projection-based) can be combined into a single differentiable gamma function.

In contrast to convention approaches, that handled multiple obstacles by combining modulations, the disclosed methodology handles multiple obstacles by combining their representations into a single function. This is accomplished using a differentiable minimum approach identical to that described in equations (42)-(46) but operating over obstacle representations Γᵢ(x):

$${\hat{Γ}}_{∇} ( x ) = - \frac{1}{ρ} log ( {\sum }_{i} exp ( - ρ \cdot {Γ}_{i} ( x ) ) ) \qquad ( 62 )$$

$$∇ {\hat{Γ}}_{∇} ( x ) = \frac{{\sum }_{i} exp ( - ρ \cdot {Γ}_{i} ( x ) ) \cdot ∇ {Γ}_{i} ( x )}{{\sum }_{i} exp ( - ρ \cdot {Γ}_{i} ( x ) )} \qquad ( 63 )$$

$${∇}^{2} {\hat{Γ}}_{∇} ( x ) = \frac{1}{\sum w ( x )} ( {\sum }_{i} ζ ( i , x ) - ( {\sum }_{i} ∇ w ( x ) ) ∇ {{\hat{Γ}}_{∇} ( x )}^{T} ) \qquad ( 64 )$$

$$ζ ( i , x ) = ( ∇ w ( x ) \cdot ∇ {{Γ}_{i} ( x )}^{T} + w ( x ) \cdot {∇}^{2} {Γ}_{i} ( x ) ) \qquad ( 65 )$$

$$w ( x ) = exp ( - ρ \cdot {Γ}_{i} ( x ) ) \qquad ( 66 )$$

$$∇ w ( x ) = - w ( x ) ρ ∇ {Γ}_{i} ( x ) \qquad ( 67 )$$

ρ is the relaxation parameter from the differentiable minimum. ζ is an additional term in the calculation. \hat{Γ}(x) is an approximation of the projection based obstacle representation. Equation 62 is a differentiable minimum and is used in two places: first with the sample representation, and later as a multiple obstacle interface. Equation (62) is from the latter case: here, the Gamma_i terms represent other obstacle representations, and are combined into a single representation using this equation. The output is a single real value that is analogous to the minimum distance to the closest obstacle. The “hat” over the gamma represents a carry over from the introduction of the differentiable minimum (itself being an approximation to the minimum function). It indicates that the representation is based on an approximation. The function is still scalar, although the derivative will be a vector, as with the other representations.

Leveraging a single obstacle representation allows a single modulation approach to govern dynamics. This is preferable in the context of planning as the on-manifold dynamics operate over the isosurfaces generated by all obstacles, and require no further blending or optimization. Note that the differentiable minimum function used here can cause sharp ridges in the obstacle representation for large values of ρ, and combining representations in this way violates the monotonicity requirement stated in equation (19) (breaking requirements for convergence under standard modulation techniques).

Using the on-manifold planning approach described herein, monotonicity is not explicitly required for each and every point to ensure convergence; instead monotonicity is only strictly required below the shifted boundary Γ(x)=γ for which this property is leveraged by the gradient ascent. Examples of modulation using multiple obstacles can be seen in FIGS. 13A-13B.

Process 300 returns the obstacle representations in block 340. The obstacle representations are returned as a gamma function, using the combined gamma function produced in block 330. Such an obstacle representation may be similar to or the same as the obstacle representation used in block 220 in process 200.

Conventional systems are limited to avoiding dynamic obstacles which may be represented using convex or star-shaped obstacle representations. Thus, conventional systems are unable to avoid dynamic obstacles represented with general non-convex shapes (i.e., obstacles or objects which preferably should not be represented using a star-shaped obstacle representations). The disclosed approach constructs a modulation matrix M(x) that (a) avoids the generation of spurious attractors arising from collinearity (i.e. stopping on the edge of an obstacle when n and f_{g} are collinear), (b) enables isosurface tracking, and (c) enables introduction of on-manifold strategies for circumnavigating non-convex obstacles.

A DS based modulation strategy for non-convex obstacles in accordance with the concepts described herein utilizes manifold navigation methods based on approximated geodesics of an extended isosurface of the non-convex obstacle representation. In this way, the described DS modulation strategy leverages an on-manifold planning methodology and provides several methods for real-time on-manifold navigation around non-convex obstacles. Thus, the control technique is effective for controlling dynamical systems when maneuvering around multiple non-convex obstacles. The control technique provides a reactive control approach, which allows operation of dynamical systems in the presence of non-convex obstacles while preserving guarantees of stability and convergence.

Further, the two obstacle representation techniques are capable of modeling complex obstacles and workspaces while representing the complex obstacles and workspaces as a single object boundary function. The first obstacle representation includes a computationally efficient sample-based representation for describing arbitrary non-convex obstacles. The second obstacle representation includes a projection-based representation for describing continuous, well-defined surfaces such as planes, columns, and ellipsoids. Such sample and projection-based representations can be combined to represent multiple obstacles and obstacle types (sample-based or projection-based) with a single, continuously differentiable function.

Empirical evaluations demonstrate real-time (real time meaning less than 1 millisecond (ms)) reactive collision avoidance and target tracking on both two-dimensional (2D) and three-dimensional (3D) examples, as well as on a physical robot with a human collaborator and a series of obstacles. In one example embodiment, reactive control of a seven degrees-of-freedom (7DoF) manipulator with dynamic obstacles (including humans) was implemented utilizing a 1 Kilohertz (kHz) control loop rate. Using the sample-based representation described herein, an obstacle representation function was calculated or otherwise determined in less than 1 ms with up to 35,000 sampled data points using a CPU implementation, and up to 600,000 sampled data points with a GPU implementation.

Various embodiments of the concepts, systems, devices, structures, and techniques sought to be protected are described herein with reference to the related drawings. Alternative embodiments can be devised without departing from the scope of the concepts, systems, devices, structures, and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method comprising:
(a) generating a dynamical system model of a system configured to operate in an environment;
(b) collecting data via one or more sensors;
(c) processing the collected data to generate object representations of non-convex objects in the environment;
(d) generating approximated geodesics of one more extended isosurfaces of the object representations of non-convex objects;
(e) modulating the dynamical systems model using a manifold based on approximated geodesics of the one more extended isosurfaces of the object representations of non-convex objects; and
(f) providing one or more control signals for the system.

2. The method of claim 1, wherein the non-convex objects are dynamic non-convex objects.

3. The method of claim 1, wherein processing the collected data to generate object representations of non-convex objects in the environment comprises generating a sample-based representation of at least one non-convex object.

4. The method of claim 3, wherein generating a sample-based representation of at least one non-convex object comprises generating at least one of: a quadratic obstacle field; and an exponential obstacle field.

5. The method of claim 1, wherein processing the collected data to generate object representations of non-convex objects in the environment comprises generating a projection-based representation of at least non-convex object.

6. The method of claim 1, wherein:
processing the collected data to generate object representations of non-convex objects in the environment comprises generating projection-based object representations of multiple objects in the environment by combining multiple object representations into a single function; and
providing one or more control signals for the system comprises providing one or more control signals to a robot which causes the robot to move in three dimensions while avoiding dynamic obstacles during the movement in three-dimensions.

7. A control system for use with an autonomous system, the control system comprising:
a processing system configured to:
define a dynamical system model of the autonomous system;
process sensor data to define object representations of non-convex objects in an operating environment;
modulate the dynamical system model using a manifold based upon approximated geodesics of one more extended isosurfaces of the object representations of non-convex objects; and
provide control signals to the autonomous system based upon the modulated dynamical system model.

8. The control system of claim 7, wherein the processing system is configured to generate a sample-based object representation of at least one non-convex object in the operating environment.

9. The control system of claim 7, wherein the processing system is configured to generate a projection-based object representation of at least one non-convex object in the operating environment.

10. The control system of claim 7 wherein processing sensor data to define object representations of non-convex objects in an operating environment comprises creating a quadratic obstacle field Γ_{f}(x,τ) as:
$${Γ}_{f} ( x , τ ) = α ( {‖ x - f ( τ ) ‖}_{2}^{2} - {s ( τ )}^{2} ) + 1 ,$$
$$∇ {Γ}_{f} ( x , τ ) = 2 \cdot α \cdot ( x - f ( τ ) ) ,$$
$${∇}^{2} {Γ}_{f} ( x , τ ) = 2 \cdot α \cdot II ,$$
In which:
Γ_{f}(x,τ) is an obstacle field,
ƒ(τ) is a continuous function describing a path representation of the obstacle,
τ is a point on the representation of the obstacle,
α is a weighting parameter,
x is a d-dimensional state-space of a robotic system and a field scaling parameter, and
s(τ) is a boundary function parameter to control a boundary of the obstacle field.

11. The control system of claim 7 wherein processing sensor data to define object representations of non-convex objects in an operating environment comprises creating an exponential field obstacle field Γ_{f}(x,τ) as:
$${Γ}_{f} ( x , τ ) = exp ( α \cdot {‖ f ( x ) ‖}_{s}^{m} ) ,$$
$$∇ {Γ}_{f} ( x , τ ) = α \cdot m \cdot {‖ f ( x ) ‖}_{s}^{m - 1} \cdot \frac{f ( x )}{{‖ f ( x ) ‖}_{2}} \cdot {Γ}_{f} ( x , τ ) ,$$
$${∇}^{2} {Γ}_{f} ( x , τ ) = α \cdot m \cdot {Γ}_{f} ( x , τ ) \frac{{‖ f ( x ) ‖}_{s}^{m - 2}}{{‖ f ( x ) ‖}_{2}^{2}} ( ζ \cdot f ( x ) {f ( x )}^{T} + {‖ f ( x ) ‖}_{s} {‖ f ( x ) ‖}_{2} \cdot II )$$
$$ζ ( x , τ ) = ( m - 1 ) + α \cdot m \cdot {‖ f ( x ) ‖}_{s} \cdot {( α \cdot {‖ f ( x ) ‖}_{2} - s ( τ ) )}^{m - 1} - \frac{{‖ f ( x ) ‖}_{s}}{{‖ f ( x ) ‖}_{2}} ,$$
in which:
Γ_{f}(x,τ) is an obstacle field,
x is a d-dimensional state-space of a robotic system,
m is a value and corresponds to a power to which the distance is raised,
s(τ) is a boundary function parameter to control a boundary of the obstacle field,
α is a weighting parameter,
ζ is an additional term in the calculation,
Π is an identity matrix,
ƒ(τ) is a continuous function describing a path representation of the obstacle,
$$f ( x ) = x - f ( τ ) ,$$
$${‖ f ( x ) ‖}_{2} = {‖ x - f ( τ ) ‖}_{2} , and$$
$${‖ f ( x ) ‖}_{s} = ( {‖ x - f ( τ ) ‖}_{2} - s ( τ ) ) .$$

12. The control system of claim 7 wherein modulating the dynamical system model using a manifold based on approximated geodesics of one more extended isosurfaces of the object representations of non-convex objects comprises forming a modulation matrix M′(x) expressed as:
$${M}^{′} ( x ) = M ( x ) + H ( x ) [ \begin{matrix}0 \\ {E}^{T} ϕ ( x )\end{matrix} ] [ 10 ] {H ( x )}^{T}$$
in which:
M(x) is a modulation matrix from a classical modulation approach where:
$$M ( x ) = H ( x ) Λ ( x ) {H ( x )}^{T}$$
H(x) is an orthonormal basis function [\hat{n} e₁ . . . e_{d-1}]
x is a d-dimensional state-space of a robotic system,
\hat{n} is a normal vector
[e₁ . . . e_{d-1}] and is a collection of basis vectors orthogonal to ∇Γ(x) used to construct the orthonormal basis H(x)
$$E = [ {e}_{1} … {e}_{d - 1} ]$$
E^{T} is a transpose of E
φ(x) is an on-manifold dynamics term
H(x)^{T} is a transpose of H(x) such that H(x)^{T}H(x) is the identity matrix I.

13. The control system of claim 7 wherein the processing system is configured to generate a projection-based object representations of objects in the operating environment by generating a projection based obstacle representation expressed as:
$$Γ ( x ) = exp ( α \cdot ( {‖ P ( x - r ) ‖}_{2} - s )$$
where:
Γ is a gamma function,
x is a d-dimensional state-space of a robotic system,
Γ(x) is a projection based obstacle representation and is a scalar function,
P is a projection matrix
r is a center of the object,
s is an offset:
where Γ(x) has a gradient which may be expressed as:
$$∇ Γ ( x ) = α \cdot \frac{Γ ( x )}{{‖ P ( x - r ) ‖}_{2}} {P}^{T} P ( x - r )$$
where P^{T} is a transposed of P and Γ(x) has a Hessian which may be expressed as:
$${∇}^{2} Γ ( x ) = α \cdot \frac{Γ ( x )}{{‖ P ( x - r ) ‖}_{2}} ( {P}^{T} P + ( \frac{α}{{‖ P ( x - r ) ‖}_{2}} - \frac{1}{{‖ P ( x - r ) ‖}_{2}^{2}} ) {P}^{T} P ( x - r ) {( x - r )}^{T} {P}^{T} P ) .$$

14. The control system of claim 7 wherein the processing system is configured to generate a projection-based object representations of multiple objects in the operating environment by combining multiple object representations into a single function.

15. The control system of claim 14 wherein the processing system is configured to generate a projection-based object representations of multiple objects in the operating environment by combining multiple object representations Γᵢ(x) into a single function expressed as:
$${\hat{Γ}}_{∇} ( x ) = - \frac{1}{ρ} log ( {\sum }_{i} exp ( - ρ \cdot {Γ}_{i} ( x ) ) )$$
$$∇ {\hat{Γ}}_{∇} ( x ) = \frac{{\sum }_{i} exp ( - ρ \cdot {Γ}_{i} ( x ) ) \cdot ∇ {Γ}_{i} ( x )}{{\sum }_{i} exp ( - ρ \cdot {Γ}_{i} ( x ) )}$$
$${∇}^{2} {\hat{Γ}}_{∇} ( x ) = \frac{1}{\sum w ( x )} ( {\sum }_{i} ζ ( i , x ) - ( {\sum }_{i} ∇ w ( x ) ) ∇ {{\hat{Γ}}_{∇} ( x )}^{T} )$$
$$ζ ( i , x ) = ( ∇ w ( x ) \cdot ∇ {{Γ}_{i} ( x )}^{T} + w ( x ) \cdot {∇}^{2} {Γ}_{i} ( x ) )$$
$$w ( x ) = exp ( - ρ \cdot {Γ}_{i} ( x ) )$$
$$∇ w ( x ) = - w ( x ) ρ ∇ {Γ}_{i} ( x )$$
where:
Γ is the gamma function,
i is an index corresponding to the ith object,
Γ(x) is a projection based obstacle representation,
\hat{Γ}(x) is an approximation of the projection based obstacle representation,
ρ is the relaxation parameter from the differentiable minimum,
ζ is an additional term in the calculation, and
w(x) is introduced for notation reasons.

16. An autonomous system comprising:
a control system comprising:
a processing system configured to:
define a dynamical system model of the autonomous system;
process sensor data to define an object representation of at least one non-convex objects in an operating environment;
modulate the dynamical system model using a manifold based upon approximated geodesics of one more extended isosurfaces of the object representations of the at least one non-convex objects; and
providing control signals to the autonomous system.

17. The autonomous system of claim 16, wherein the object representations of at least one non-convex objects comprises a sample-based representation.

18. The autonomous system of claim 16, wherein the at least one object representation corresponds to a projection-based representation.

19. The autonomous system of claim 16, wherein the processing system is configured to generate projection-based object representations of multiple objects in the operating environment by combining multiple object representations into a single function.

20. The autonomous system of claim 16, wherein the autonomous system is a robot and the processing system provides one or more control signals to the robot which cause the robot to move in three dimensions while avoiding dynamic obstacles during the movement in three-dimensions.
